(19) United States
(12) Patent Application Publication
(10) Pub. No.: US 2019/0050115 A1
(43) Pub. Date: Feb. 14, 2019

(54) TRANSITIONING BETWEEN GRAPHICAL INTERFACE ELEMENT MODALITIES BASED ON COMMON DATA SETS AND CHARACTERISTIC OF USER INPUT

(71) Applicant: Google LLC, Mountain View, CA (US)

(72) Inventors: Golden Gopal Krishna, Berkeley, CA (US); Mindy Pereira, Santa Clara, CA (US); Carl Magnus Borg, San Francisco, CA (US); Henry Owen Newton-Dunn, Mountain View, CA (US); Lily Sin, San Fransisco, CA (US); Glen Murphy, Palo Alto, CA (US); Miroslav Bojic, San Francisco, CA (US)

(21) Appl. No.: 15/675,092

(22) Filed: Aug. 11, 2017

(51) Int. Cl. G06F 3/0482; G06F 3/0488; G06F 3/041

(52) U.S. Cl. CPC G06F 3/0482; G06F 3/04817; G06F 3/0414; G06F 3/04883

(57) ABSTRACT

In general, techniques are described for enabling a computing device to expand an element associated with an application in order to show different sets of actions associated with the application. The computing device displays a graphical user interface including an interface element associated with the application. The computing device receives an indication of user input. The computing device determines a characteristic of the user input and whether the characteristic is a first characteristic or a second characteristic. The computing device, responsive to determining that the characteristic of the user input is the first characteristic, outputs, for display, a first set of sub-elements or, responsive to determining that the characteristic of the user input is the second characteristic, outputs, for display, a second set of sub-elements. Each sub-element in the first and second sets of sub-elements is associated with unique actions associated with the application.

### BACKGROUND

A graphical user interface (GUI) may include interface elements (referred to as “icons”) with which a user may interact to launch applications. A GUI may also include other interface elements (referred to as “widgets”) associated with installed applications. The widgets may provide additional information to the user about the associated application, beyond what may typically be conveyed by an icon. A particular application may be associated with a number of different widgets having different static graphical output modalities (e.g., as defined by size, shape, and extent of information provided). The user may select which of the different widgets to install, whereupon the installed widget may remain static, for example, in terms of the graphical output modality. Furthermore, the information and/or functionality accessible via interactions with such elements may generally be the same regardless as to when a user interacts with the elements or regardless as to when the elements are displayed. As such, if a user wants to access information or actions within an application that are different from the information or functions associated with the widget, the user may need to install a different one of the associated widgets and/or execute and interact with the underlying application itself.

### SUMMARY

In general, this disclosure is directed to techniques that may enable a computing device to expand an interface element (such as an icon or widget) associated with an application to show different sets of information or actions associated with the corresponding application than what is currently being displayed. The specific set of information and actions shown may be dependent on a characteristic of the user input received at the interface element, such as a direction of a gesture input, a pressure of a touch input, or a duration of a touch input.

In some instances, the actions in each action set may depend on device/user context. For instance, a computing device may, as one example, display a graphical user interface (GUI) that includes an interface element associated with a text messaging application. The computing device may receive an indication of a gesture user input interacting with the interface element for the text messaging application and determine a characteristic of the gesture user input, such as a direction of the gesture. The computing device may, for instance, determine whether the gesture user input has a first characteristic (e.g., a horizontal direction) or a second characteristic (e.g., a vertical direction). When the computing device determines that the gesture user input has the first characteristic (e.g., a horizontal direction), the computing device may transition from a first interface element generated according to a first graphical output modality (e.g., an icon) for display in the GUI as a second interface element generated according to a second graphical output modality (i.e., a horizontal widget with a horizontal arrangement of one or more information sub-elements and/or one or more action sub-elements in this example). Conversely, if the computing device determines that the gesture user input has the second characteristic (e.g., a vertical user input), the computing device may transition from the first interface element generating according to the first graphical output modality to a second interface element generated according to a third different graphical output modality (i.e., a vertical widget with a vertical arrangement of one or more sub-elements, which may generally refer to information sub-elements and/or action sub-elements).

By enabling the display different sets of sub-elements according to different user inputs, techniques of this disclosure may provide a way for a user to quickly view specific and advanced information and/or perform specific and advanced actions associated with the corresponding application without requiring the user to first open the application or perform a customization process on the interface element associated with the application. Further, by expanding a single interface element to include different information sub-elements, a GUI may dynamically provide additional information to a user as needed with a liquid-like interface element without having to waste valuable space on the GUI by displaying a full-sized static widget at all times. In this way, techniques of this disclosure may reduce the amount of time and the number of user inputs required to retrieve relevant sub-elements associated with the application, which may simplify the user experience and may reduce power consumption of the computing device.

Furthermore, the computing device may transition between the interface elements generated according to different graphical output modalities based on the same data set (or, in other words, a data set common to both graphical output modalities). Rather than define separate data sets to support each of the different static interface elements, the techniques may enable the computing device to define a single data set common to the different graphical output modalities associated with the application. As such, the application programming interface (API) may provide for different function calls (which may be referred to as “calls” or “API calls”) that all rely on the same data set, but that enable the generation of the different interface elements according to the different graphical output modalities. Reliance on a single common data set may simplify and speed coding of the different interface elements as software developers may not need to maintain disparate data sets. As a result of facilitating development of different interface elements, the techniques may potentially increase user availability to different interface elements, while allowing the computing device to provide dynamic customization of interface elements tailored to the current device and/or user context.

In one example, the disclosure is directed to a method that includes displaying, by a computing device, at a display device, a graphical user interface including an interface element associated with an application on the computing device. The method also includes receiving, by the computing device, an indication of user input detected at an area of a presence-sensitive input device. The area of the presence-sensitive input device corresponds to a location of the display device at which the interface element in the graphical user interface is displayed. The method further includes determining, by the computing device, a characteristic of the user input. The method also includes determining, by the computing device, whether the characteristic of the user input is a first characteristic or a second characteristic different than the first characteristic. The method further includes, responsive to determining that the characteristic of the user input is the first characteristic, outputting, by the computing device, for display at the display device, a first set of sub-elements. The method further includes, responsive to determining that the characteristic of the user input is the second characteristic, outputting, by the computing device, for display at the display device, a second set of sub-elements different from the first set of sub-elements. Each sub-element in the first set of sub-elements and each sub-element in the second set of sub-elements is associated with unique actions associated with the application.

In another example, the disclosure is directed to a computing device that includes a display device, a presence-sensitive input device, at least one processor, and a memory that stores instructions. When executed, the instructions may cause the at least one processor to display, at the display device, a graphical user interface including an interface element associated with an application on the computing device. The instructions may further cause the at least one processor to receive an indication of user input detected at an area of the presence-sensitive input device. The area of the presence-sensitive input device corresponds to a location of the display device at which the interface element in the graphical user interface is displayed. The instructions may also cause the at least one processor to determine a characteristic of the user input. The instructions may further cause the at least one processor to determine whether the characteristic of the user input is a first characteristic or a second characteristic different than the first characteristic. The instructions may also cause the at least one processor to, responsive to determining that the characteristic of the user input is the first characteristic, output, for display at the display device, a first set of sub-elements. The instructions may further cause the at least one processor to, responsive to determining that the characteristic of the user input is the second characteristic, output, for display at the display device, a second set of sub-elements different from the first set of sub-elements. Each sub-element in the first set of sub-elements and each sub-element in the second set of sub-elements is associated with unique actions associated with the application.

In another example, the disclosure is directed to a non-transitory computer-readable storage medium storing instructions that, when executed, cause at least one processor of a computing device to display, at a display device, a graphical user interface including an interface element associated with an application on the computing device. The instructions may further cause the at least one processor to receive an indication of user input detected at an area of a presence-sensitive input device. The area of the presence-sensitive input device corresponds to a location of the display device at which the interface element in the graphical user interface is displayed. The instructions may also cause the at least one processor to determine a characteristic of the user input. The instructions may further cause the at least one processor to determine whether the characteristic of the user input is a first characteristic or a second characteristic different than the first characteristic. The instructions may also cause the at least one processor to, responsive to determining that the characteristic of the user input is the first characteristic, output, for display at the display device, a first set of sub-elements. The instructions may further cause the at least one processor to, responsive to determining that the characteristic of the user input is the second characteristic, output, for display at the display device, a second set of sub-elements different from the first set of sub-elements. Each sub-element in the first set of sub-elements and each sub-element in the second set of sub-elements is associated with unique actions associated with the application.

In another example, the disclosure is directed to a computing device that includes means for displaying, at a display device, a graphical user interface including an interface element associated with an application on the computing device. The computing device also includes means for receiving an indication of user input detected at an area of a presence-sensitive input device. The area of the presence-sensitive input device corresponds to a location of the display device at which the interface element in the graphical user interface is displayed. The computing device further includes means for determining a characteristic of the user input. The computing device also includes means for determining whether the characteristic of the user input is a first characteristic or a second characteristic different than the first characteristic. The computing device further includes, responsive to determining that the characteristic of the user input is the first characteristic, means for outputting, for display at the display device, a first set of sub-elements. The computing device further includes, responsive to determining that the characteristic of the user input is the second characteristic, means for outputting, for display at the display device, a second set of sub-elements different from the first set of sub-elements. Each sub-element in the first set of sub-elements and each sub-element in the second set of sub-elements is associated with unique actions associated with the application.

In another example, the disclosure is directed to a method that includes performing, by one or more processors of a computing device, a first call of an application programming interface (API) to generate, based on a data set, an interface element conforming to a first graphical interface modality of a plurality of graphical interface modalities for an application. The method further includes outputting, by the one or more processors and for display, the first interface element. The method also includes performing, by the one or more processors, a second call of the API to generate, based on the data set, a second interface element conforming to a second graphical interface modality of the plurality of graphical interface modalities for the application, the second graphical interface modality being different than the first graphical interface modality. The method further includes outputting, by the one or more processors and for display, the second interface element.

In another example, the disclosure is directed to a device that includes a memory configured to store a data set. The device further includes one or more processors configured to perform a first call of an application programming interface (API) to generate, based on a data set, an interface element conforming to a first graphical interface modality of a plurality of graphical interface modalities for an application. The device also includes a display configured to display the first interface element. The one or more processors are further configured to perform a second call of the API to generate, based on the data set, a second interface element conforming to a second graphical interface modality of the plurality of graphical interface modalities for the application, the second graphical interface modality being different than the first graphical interface modality. The display is further configured to display the second interface element.

In another example, the disclosure is directed to a non-transitory computer-readable storage medium having stored thereon instructions. When executed, the instructions cause the one or more processors to perform a first call of an application programming interface (API) to generate, based on a data set, an interface element conforming to a first graphical interface modality of a plurality of graphical interface modalities for an application. The instructions further cause the one or more processors to output, for display, the first interface element. The instructions also cause the one or more processors to perform a second call of the API to generate, based on the data set, a second interface element conforming to a second graphical interface modality of the plurality of graphical interface modalities for the application, the second graphical interface modality being different than the first graphical interface modality. The instructions further cause the one or more processors to present, for display, the second interface element.

In another example, the disclosure is directed to an apparatus that includes means for performing a first call of an application programming interface (API) to generate, based on a data set, an interface element conforming to a first graphical interface modality of a plurality of graphical interface modalities for an application. The apparatus further includes means for outputting, for display, the first interface element. The apparatus also includes means for performing a second call of the API to generate, based on the data set, a second interface element conforming to a second graphical interface modality of the plurality of graphical interface modalities for the application, the second graphical interface modality being different than the first graphical interface modality. The apparatus further includes means for outputting, for display, the second interface element.

The details of one or more examples of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a conceptual diagram illustrating an example computing device configured to determine a characteristic of received user input and output a corresponding set of sub-elements associated with an application on the computing device, in accordance with one or more aspects of the techniques described in this disclosure.

FIG. 2 is a block diagram illustrating an example computing device configured to determine a characteristic of received user input and output a corresponding set of sub-elements associated with an application on the computing device, in accordance with one or more aspects of the techniques described in this disclosure.

FIG. 3 is a block diagram illustrating an example system that includes a computing device that outputs screen content for display at a remote device, in accordance with one or more aspects of the techniques described in this disclosure.

FIGS. 4A-4B are conceptual diagrams illustrating a sequence of operations for an example computing device configured to determine a characteristic of received user input and output a corresponding set of sub-elements associated with an application on the computing device, in accordance with one or more aspects of the techniques described in this disclosure.

FIG. 5 is a flowchart illustrating further example operations of an example computing device configured to determine a characteristic of received user input and output a corresponding set of sub-elements associated with an application on the computing device, in accordance with one or more aspects of the techniques described in this disclosure.

FIG. 6 is a flowchart illustrating example operation of computing device 210 in performing various aspects of the techniques described in this disclosure.

### DETAILED DESCRIPTION

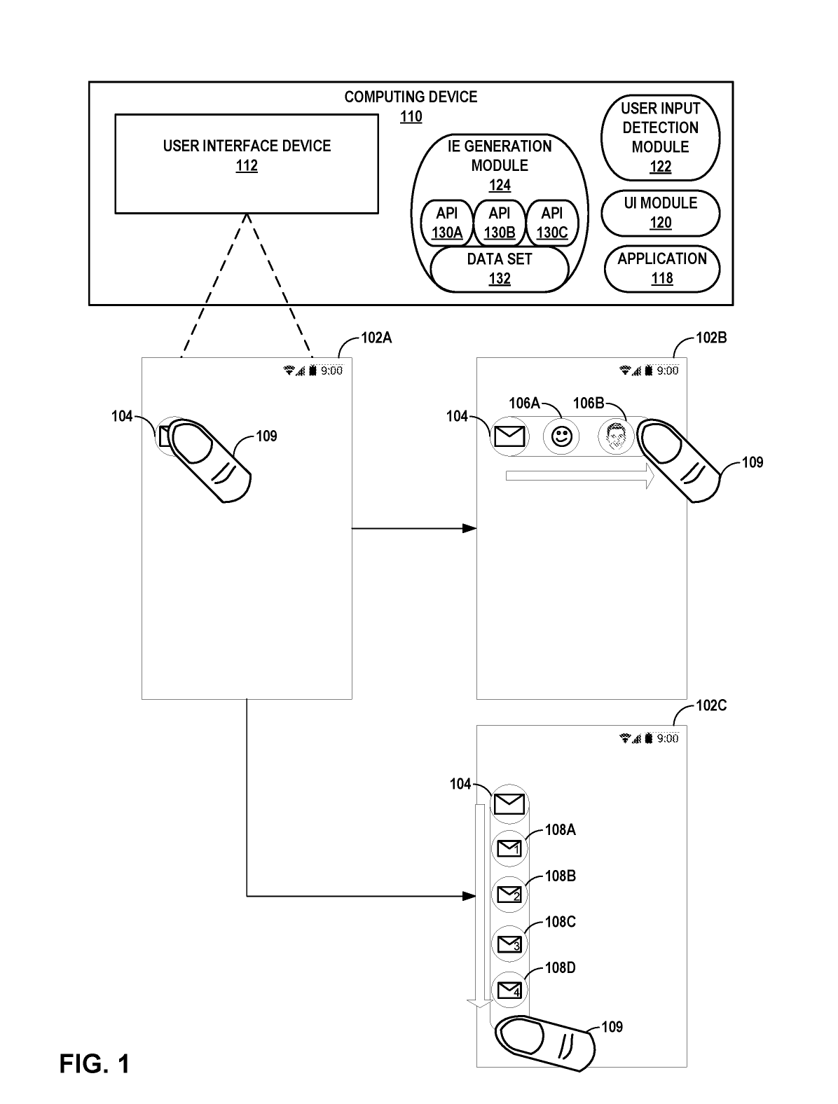

FIG. 1 is a conceptual diagram illustrating an example computing device 110 configured to determine a characteristic of received user input and output a corresponding set of sub-elements 106A-106B or 108A-108D associated with an application 118 on computing device 110, in accordance with one or more aspects of the techniques described in this disclosure. In the example of FIG. 1, computing device 110 represents an individual mobile or non-mobile computing device. Examples of computing devices 110 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or home assistant device), a personal digital assistants (PDA), a gaming system, a media player, an e-book reader, a mobile television platform, an automobile navigation or infotainment system, or any other type of mobile, non-mobile, wearable, and non-wearable computing device configured to execute an application (e.g., application 118), receive user input, and determine characteristics of the received input.

Computing device 110 includes a user interface device (UID) 112. UID 112 of computing device 110 may represent any type of device configured to function as an input and/or output device for computing device 110. For instance, UID 112 may represent an input device using presence-sensitive input screens, such as resistive touchscreens, surface acoustic wave touchscreens, capacitive touchscreens, projective capacitance touchscreens, pressure sensitive screens, acoustic pulse recognition touchscreens, and/or any other type of presence-sensitive display. When representative of a presence-sensitive display, UID 112 may receive indications of tactile input by detecting one or more gestures from a user (e.g., the user touching or pointing to one or more locations of UID 112 with a finger or a stylus pen).

UID 112 may represent, either as an alternative to or in conjunction with the presence-sensitive input screens, a microphone, an infrared sensor, and/or any other type of input device. For example, UID 112 may detect, using a built-in microphone, voice input that UI module 120 and/or user input detection module 122 processes for detecting different inputs.

UID 112 may also represent an output (e.g., display) device configured to present an output to a user. When representative of an output device, UID 112 may be configured to use one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110. As an alternative to or in conjunction with display devices, UID 112 may also include other output devices, such as a speaker, a haptic feedback device, or other types of output devices configured to output information to a user. UID 112 may present a user interface (e.g., user interface 102A, 102B, or 102C) including interface element 104 (which may also be referred to as “graphical interface element 104) and various sets of action sub-elements (e.g., 106A-106B and 108A-108D). UID 112 may present a user interface related to other features of computing platforms, operating systems, applications, and/or services executing at and/or accessible from computing device 110 (e.g., e-mail, chat, online services, telephone, gaming, etc.).

Computing device 110 further includes an application 118, a user interface (UI) module 120, a user input detection module 122, and an interface element (IE) generation module 124 (“IE generation module 124”). Application 118 and modules 120, 122, and 124 may perform operations described using hardware or a combination of hardware and software or firmware residing in and/or executing at computing device 110. One or more processors of computing device 110, or processors of multiple devices, may execute instructions that are stored at a memory or other non-transitory storage medium of computing device 110 to perform the operations of application 118 and modules 120, 122, and 124. Computing device 110 may execute application 118 and modules 120, 122, and 124 as virtual machines executing on underlying hardware. Application 118 and modules 120, 122, and 124 may execute as one or more services of an operating system or computing platform. Application 118 and modules 120, 122, and 124 may execute as one or more executable programs at an application layer of a computing platform.

UI module 120 manages user interactions with UID 112 and other components of computing device 110. In other words, UI module 120 may act as an intermediary between various components of computing device 110 to make determinations based on user input detected by UID 112 and generate output at UID 112 in response to the user input. An application, service, platform or other module of computing device 110 may invoke UI module 120 to interface with UID 112 so as to output a user interface (e.g., user interface 102A). UI module 120 may manage inputs received by computing device 110 via UID 112 as a user views and interacts with the user interface presented at UID 112 and update the user interface in response to receiving information from the application, service, platform, or other module of computing device 110 that is processing the user input.

In the example of FIG. 1, application 118 may be a text messaging application, and interface element 104 may be a shortcut icon to access application 118. Although shown in FIG. 1 as a single application 118, application 118 may also be two or more applications that may each be executed by computing device 110. For instance, computing device 110 may execute, to provide a few examples, a text messaging application, an email application, multiple gaming applications, and multiple social networking applications, each of which are represented in FIG. 1 by application 118.

As shown in FIG. 1, user interface 102A is a user interface for a home screen of an operating system. The home screen, in general, may include one or more interface elements, including interface element 104, that are each associated with various applications stored on computing device 110. The various interface elements may also include visual representations of the application with which the respective interface element is associated. However, user interface 102A may be any graphical user interface produced during the execution of an operating system or an application that includes an interface element associated with application 118. In the example of FIG. 1, user interface 102A includes interface element 104, which is an element associated with application 118. In other instances, user interface 102A may also be a voice-based user interface, with interface element 104 being a voice-based interface element. In such instances, computing device 110 may receive voice inputs to interact with interface element 104 in accordance with the techniques described herein.

In some examples, UID 112 may receive tactile input from a user of computing device 110, such as using tactile object 109. In some examples, UID 112 may receive indications of tactile input by detecting one or more gestures from a user in control of tactile object 109. Such gestures are sometimes called “swipes” or “drags.” Although only one contact point is described, the techniques described in this disclosure may be expanded to incorporate a multi-contact-point gesture, such as “pinch in” or “pinch out” gesture, a two-finger linear or rotational swipe, or other variants. In some examples, tactile object 109 may be a finger or a stylus pen that the user utilizes to touch or point to one or more locations of UID 112. In various instances, UID 112 may detect a user's movement (e.g., moving a hand, an arm, a pen, a stylus, etc.) within a threshold distance of UID 112. Tactile object 109 may also provide touch inputs, or inputs at an area of UID 112 that remains substantially stationary but provides varying levels of pressure to UID 112, or that remain substantially stationary at varying durations.

User input detection module 122 may represent a module configured to analyze various inputs by user inputs received by UI module 120 in order to determine one or more characteristics associated with the respective user input (which may also be referred to as a “gesture”). For instance, when UI module 120 receives tactile input of a swiping gesture from UID 112, user input detection module 122 may analyze the tactile input to detect the swipe gesture and determine a direction of the swiping gesture by comparing coordinates of a starting point of the swiping gesture with coordinates of an ending point of the swiping gesture. In other instances, when UI module 120 receives tactile input indicative of a substantially stationary touch input, gesture module 122 may analyze the tactile input to detect the substantially stationary touch input and determine a pressure or duration of the received tactile input through comparisons of the pressure or duration to various respective pressure or duration thresholds.

IE generation module 124 may represent a module configured to determine which interface element (and corresponding sub-elements, which may refer to information sub-elements or action sub-elements) to output in a GUI displayed on UID 112 based on the characteristic determined by user input detection module 122. For instance, when user input detection module 122 determines the characteristic to be a first characteristic, action module 124 may determine a first interface element having a first set of sub-elements to output in the GUI. Conversely, when user input detection module 122 determines the characteristic to be a second characteristic, IE generation module 124 may determine a different second interface element (and corresponding sub-elements) to output in the GUI.

In accordance with the techniques described herein, UI module 120 may display, at UID 112, user interface 102A including interface element 104 associated with application 118 on computing device 110. In the example of FIG. 1, user interface 102A may be a home screen generated by an operating system executing on computing device 110 (which is not shown for ease of illustration purposes). The operating system of computing device 110 may invoke UI module 120 to output user interface 102A for display at UID 112.

When invoked (often by way of interrupts), UI module 120 may retrieve an indication of tactile input entered by the user (which may be referred to generally as “user input”) detected at an area of UID 112 at which a portion of user interface 102A is displayed. The area of UID 112 may correspond to a location of UID 112 at which interface element 104 is displayed within graphical user interface 102A. The user input may be a user interaction representative of an instruction to display, on UID 112, a limited representation of functionality of application 118 relative to an opened state of application 118 (such as a widget). For instance, the user, using tactile object 109, may interact with computing device 110 by beginning a user input with tactile object 109 at an area of UID 112 that is displaying interface element 104. In some examples, the user input may be a touch input from tactile object 109 with a particular amount of pressure. In the example of FIG. 1, the user input may be a swipe input with a beginning point at an area of UID 112 corresponding to interface element 104.

User input detection module 122 may analyze the user input and thereby determine a characteristic of the user input. The user input received by UI module 120 may be provided by the user in a particular way (e.g., with a specific characteristic). In some examples, when the user input is a substantially-stationary touch input, the characteristic of the user input may be an amount of pressure that tactile object 109 applies to UID 112 or a duration that the tactile object 109 applies pressure to UID 112. In other examples, when the user input is a gesture input, the characteristic of the user input may be a direction of the swiping gesture. In still other examples, the characteristic may be a length of time (or, in other words, duration) that tactile object 109 is within the necessary distance of UID 112. The characteristic may also be some combination of the above three examples. In the example of FIG. 1, the characteristic of the user input is a direction of the swiping gesture input by tactile object 109.

There may be numerous characteristics of user inputs. For example, as described above, the characteristic may be a pressure, a direction of a gesture, a duration of the input, or some combination of the three. In examples where the characteristic is a pressure, the first characteristic may be a first range of pressures, and the second characteristic may be a second range of pressures, with the pressures in the second range of pressures being greater than the pressures in the first range of pressures. In examples where the characteristic is a duration of the input, the first characteristic may be a first range of times, and the second characteristic may be a second range of times, with the various times in the second range of times being greater than the various times in the second range of times.

User input detection module 122 may determine whether the characteristic of the user input is a first characteristic, a second characteristic different than the first characteristic, or even some other third characteristic different from the first and second characteristics. For example, where the characteristic is a direction of a gesture, the first characteristic may be a substantially horizontal gesture (e.g., the change in X coordinates along the gesture is greater than the change in Y coordinates along the gesture) and the second characteristic may be a substantially vertical gesture (e.g., the change in Y coordinates along the gesture is greater than the change in X coordinates along the gesture).

User input detection module 122 of computing device 110 may receive user input in the form of a tactile input from a user of computing device 110 via UID 112. User input detection module 122 may receive indications of the tactile input by detecting one or more user inputs from a user of computing device 110 (e.g., the user touching or pointing to one or more locations of UID 112 with tactile object 109). For example, UID 112 may present graphical user interface 102A that includes graphical components of a computing platform, operating system, applications, or services executing at or accessible by computing device 110 (e.g., interface element 104 of email application 118). A user may interact with graphical user interface 102A to cause computing devices 110 to perform operations. The user of computing device 110 may provide input to UID 112 using tactile object 109 to interact with interface element 104 to perform various aspects of the techniques described herein.

UID 112 of computing device 110 may detect input (which may be representative of two-dimensional and/or three-dimensional input) from a user of computing device 110. For instance, UID 112 may detect a movement of tactile object 109 (e.g., moving a hand, an arm, a pen, a stylus, etc.) within a threshold distance of UID 112. Responsive to receiving the user input representative of the movement via UID 112, computing device 110 may invoke user input detection module 122 to process the user input and determine a characteristic of the user input (e.g., a two-dimensional—horizontal and vertical movement—or three-dimensional—horizontal movement, vertical movement, and input force—vector representation of the movement of tactile object 109). User input detection module 122 may analyze the vector to detect, as one example, a gesture (e.g., a hand-wave, a pinch, a clap, a pen stroke, etc.) that has multiple dimensions.

For instance, UID 112 may receive user input at a first location of UID 112 that ends at a second location of UID 112 with a particular force. In some instances, the first location and the second location may be the same location, or the first location and the second location may be different locations. User input detection module 122 may retrieve an indication of the user input, including the first and second locations and the force of the input. User input detection module 122 may determine either a two-dimensional vector based solely on the difference between the first location of UID 112 and the second location of UID 112, or a three-dimensional vector based on the difference between the first location of UID 112 and the second location of UID 112 and the pressure of the input. Based on this two-dimensional or three-dimensional vector, user input detection module 122 may identify a characteristic of the user input, in accordance with various aspects of the techniques described herein.

Initially, UI module 120 may perform application programming interface (API) call 130A (“API 130A”) to generate, based on a data set 132, interface element 104 according to a first graphical output modality of a plurality of graphical output modalities. Data set 132 may include any type of data, including data provided by other modules 118, 120, 122, the operating system of computing device 110, or any other modules or components of computing device 110, and other devices (such as wearable devices, e.g., a smart watch, external devices, e.g., a service, etc.).

Examples of data set 132 may include an icon, an action, a title, a sub-heading, a caption, a full description. Data set 132 may also, in some examples, provide data relevant to each sub-element of interface element 104, such as sub-elements 106A and 106B described in more detail below. As such, the data relevant to one or more sub-elements may include data indicative of one or more of an icon associated with each of the one or more sub-elements, an action associated with each of the one or more sub-elements, a title associated with each of the one or more sub-elements, a sub-heading associated with each of the one or more sub-elements, a caption associated with each of the one or more sub-elements, and a full description associated with each of the one or more sub-elements.

Graphical output modalities may refer to different ways of presenting interface element 104, such as the icon shown in the example of FIG. 1. Although described with respect to the icon graphical output modality, the techniques may be performed with respect to various other different types of graphical output modalities, such as so-called “bubbles,” widget of varying sizes and including various different types of sub-elements, lists of sub-elements, long-press shortcuts, a graphical card, an automotive modality (such as those presented by automobile infotainment systems), and a wearable modality (such as those presented by wearable devices, including so-called “smart watches” or “smart glasses”). After generating interface element 104, UI module 120 may interface with UID 112 to output interface element 104 to the user.

Responsive to user input detection module 122 determining that the characteristic of the user input is a first characteristic, UI module 120 may perform a second API call, denoted in the example of FIG. 1 as API 130B, to generate, based on data set 132, interface element 104A or 104B according to a second graphical output modality of the plurality of graphical output modalities (i.e., the respective horizontal widget or vertical widgets shown in the example of FIG. 1). UI module 120 may output, for display at UID 112, either interface element 104A that includes a first set of action sub-elements 106A and 106B in user interface 102B. Each of action sub-elements 106A and 106B represent a first set of action sub-elements that are associated with unique actions provided by application 118. For the purposes of this disclosure, an action may represent a function that may be performed by or using application 118, or information associated with application 118. In other words, the one or more action sub-elements may enable an application function to be initiated without application 118 being open or which enable application data to be viewed without opening application 118. The limited representation of functionality of the application relative to an open state of the application may include one or more of a widget, a notification, a bubble, a now card, and a long press menu. Further, for the purposes of this disclosure, each action sub-element may be unique to the application (e.g., application 118) with which the action sub-element is associated.

Although described with respect to action sub-elements, the techniques described in this disclosure may be performed with respect to other types of sub-elements, including information sub-elements. Furthermore, although described as sub-elements, the sub-elements themselves are elements and as such may be referred to as elements. The term “sub-element” used throughout this disclosure is merely to distinguish elements 104 from elements 106 and 108 and does not impart any special or distinguishing characteristic on elements 106 and 108. In some examples, the term “sub-element” may refer to a child element associated with a parent element, in which case the term “sub-element” may refer to an element depending from another element in an ordered hierarchy of elements.

In some examples, the first set of action sub-elements may include action sub-elements associated with actions provided by application 118 that computing device 110 predicts the user may wish computing device to perform. In determining the first set of action sub-elements, IE generation module 124 may determine a context associated with application 118. The context may include contextual information based on one or more of an application usage history associated with application 118, a set of one or more shortcuts defined within application 118, a predetermined list of actions, a current background task being performed by application 118, an action associated with interface element 104, a current time, a current location, calendar data, and message data.

Prior to determining the context, UI module 120 may prompt the user of computing device 110 for explicit consent to grant IE generation module 124 access to the above information. For example, prior to retaining personal preference information or sending device information associated with the user of computing device 110, UI module 120 to present a user interface via UID 112 that requests a user to select a box, click a button, state a voice input, or otherwise provide a specific input to the user interface that is interpreted by computing device 110 as unambiguous, affirmative consent for IE generation module 124 to collect and make use of the user's personal preference information and the device information.

After receiving explicit consent to do so, and based on this determined context, IE generation module 124 may determine one or more predicted actions that the user of computing device 110 may wish to perform in application 118. IE generation module 124 may generate a respective action sub-element 106A and 106B in graphical user interface 102B based on these predicted actions.

For instance, based on user input detection module 122 determining that the gesture input is a substantially horizontal gesture (e.g., the two-dimensional or three-dimensional vector comprises a high change in horizontal location and a low or zero change in vertical location on UID 112), IE generation module 124 may analyze message data and an application usage history associated with application 118 to determine a group of contacts that the user contacts most often using the text message feature of application 118. IE generation module 124 may represent the user contacted most often via application 118 with action sub-element 106A, and IE generation module 124 may represent the user contacted the second most often via application 118 with action sub-element 106B. Via UID 112, UI module 120 may receive future indications of user input selecting one of action sub-elements 106A or 106B. Selecting one of these action sub-elements may launch application 118 and load a page within application 118 that includes an interface with which the user may interact to compose a message to the respective user or read previous messages sent to the respective user associated with the selection action sub-element 106A or 106B.

Responsive to user input detection module 122 determining that the characteristic of the user input is the second characteristic (e.g., the two-dimensional or three-dimensional vector comprises a high change in vertical location and a low or zero change in horizontal location on UID 112), UI module 120 perform a third API call (denoted in the example of FIG. 1 as “API 130C”) to generate, based on data set 132, a third interface element 104B according to a third graphical output modality of the plurality of graphical output modalities. Interface element 104B represents a vertical widget including action sub-elements 108A-108D arranged vertically with respect to one another. Interface element 104B conforms to a graphical output modality that is different than either the graphical output modality of interface element 104 (which is the original icon) and interface element 104A (which is representative of a horizontal widget that includes action sub-elements 106A and 106B arranged horizontally with respect to one another).

UI module 120 may output, for display at UID 112, interface element 104B with a second set of sub-elements 108A-108D different from the first set of sub-elements 106A-106B in user interface 102C. Each of action sub-elements 108A, 108B, 108C, and 108D in the second set of action sub-elements is associated with unique (or possibly non-unique) actions provided by application 118.

In some examples, the second set of action sub-elements may include action sub-elements associated with notification actions of application 118. In determining the second set of action sub-elements, UI generation module 124 may determine one or more notification actions associated with application 118 using an operating system executing on computing device 110. For instance, computing device 110 may receive notification data from a server associated with application 118. Computing device 110 may utilize the operating system to manage the received notification data, including arranging the notification data in a way that is easily accessible by the user of computing device 110. Based on this notification data, UI generation module 124 may generate a respective action sub-element 108A-108D in interface element 104B of graphical user interface 102C based on these predicted actions. These action sub-elements 108A-108D may be updated based on newly received notification data. For instance, after outputting action sub-elements 108A-108D, computing device 110 may receive additional notification data associated with application 118. UI generation module 124 may determine additional notification actions associated with application 118 and the additional notification data and output, in a new interface element of a potentially new graphical user interface, a third set of action sub-elements, with each action sub-element in the third set of sub-elements being an interface sub-element associated with the newly received notification data.

For instance, based on user input detection module 122 determining that the gesture input is a substantially vertical gesture, UI generation module 124 may determine the most recently received messages or a set of unread messages received using the text message feature of application 118. UI generation module 124 may represent a first unread text message received via application 118 with action sub-element 108A, a second unread text message received via application 118 with action sub-element 108B, a third unread text message received via application 118 with action sub-element 108C, and a most recently received text message via application 118 that has been read with action sub-element 108D. Via UID 112, UI module 120 may receive future indications of user input selecting one of action sub-elements 108A-108D. Selecting one of these action sub-elements may launch application 118 and load a page within application 118 that includes an interface that displays the respective text message associated with the selection one of action sub-elements 108A-108D.

By providing different sets of action sub-elements 106A-106B and 108A-108D in response to receiving different user inputs, techniques of this disclosure may provide a way for a user to quickly perform specific and advanced actions with application 118 without requiring the user to open application 118 or install a different widget that conforms to a different graphical output modality. Further, by transitioning a single interface element 104 to a different interface element 104A or 104B and thereby include different action sub-elements 106A-106B or 108A-108D, a GUI may dynamically provide additional information to a user as needed with a liquid-like interface element without having to waste valuable space on the GUI by displaying a full-sized widget at all times. In this way, techniques of this disclosure may reduce the amount of time and the number of user inputs required to retrieve relevant sub-elements associated with application 118, which may simplify the user experience and may reduce power consumption of computing device 110.

Furthermore, various aspects of the techniques described in this disclosure may enable computing device 110 to transition between interface elements 104 and 104A or 104B generated according to different graphical output modalities based on data set 132 (or, in other words, data set 132 common to both graphical output modalities). Rather than define separate data sets to support each of the different static interface elements, the techniques may enable computing device 110 to define single data set 132 common to the different graphical output modalities associated with application 118. As such, the application programming interface (API) may provide for different function calls (which may be referred to as “calls” or “API calls”) that all rely on the same data set (i.e., data set 132 in the example of FIG. 1), but that enable the generation of the different interface elements 104, 104A and 104B according to the different graphical output modalities. Reliance on common data set 132 may simplify and speed coding of different interface elements 104, 104A, and 104B as software developers may not need to maintain disparate data sets. As a result of facilitating development of different interface elements, the techniques may potentially increase user availability to different interface elements, while allowing the computing device to provide dynamic customization of interface elements 104, 104A, and 104B tailored to the current device and/or user context.

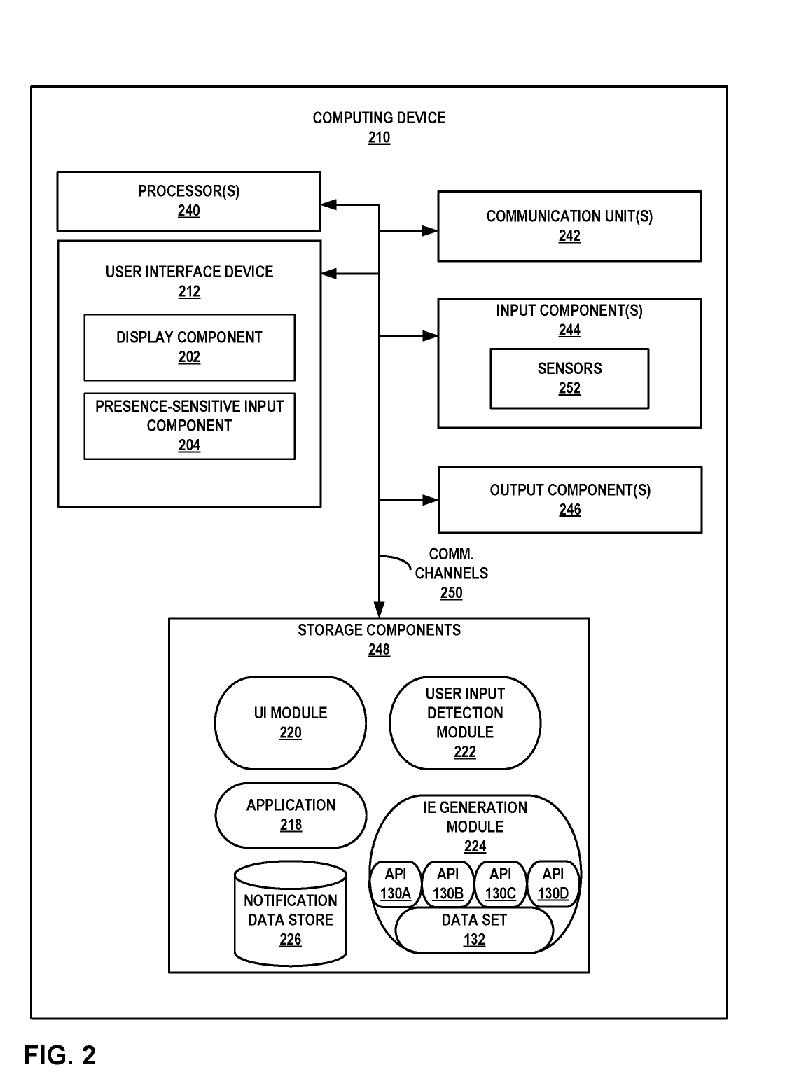

FIG. 2 is a block diagram illustrating an example computing device configured to determine a characteristic of received user input and output a corresponding set of sub-elements associated with an application on the computing device, in accordance with one or more aspects of the techniques described in this disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface device (UID) 212, one or more processors 240, one or more communication units 242, one or more input components 244, one or more output components 246, and one or more storage components 248. UID 212 includes display component 202 and presence-sensitive input component 204. Storage components 248 of computing device 210 include application 218, UI module 220, user input detection module 222, IE generation module 224, and notification data store 226.

One or more processors 240 may implement functionality and/or execute instructions associated with computing device 210 to dynamically expand an interface element associated with application 218 displayed on UID 212 of computing device 210. That is, processors 240 may implement functionality and/or execute instructions associated with computing device 210 to dynamically transition an interface element associated with application 218 displayed on UID 212 of computing device 210 between the different graphical interface modalities noted above.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 218, 220, 222, and 224. The instructions, when executed by processors 240, may cause computing device 210 to graphically transition an interface element associated with application 218 in order to display additional sub-elements associated with application 218 for display on UID 212.

UI module 220 may include all functionality of UI module 120 of computing device 110 of FIG. 1 and may perform similar operations as UI module 120 for managing a user interface (e.g., user interfaces 102A-102C) that computing device 210 provides at UID 212 for example, for facilitating interactions between a user of computing device 110 and application 218. For example, UI module 220 of computing device 210 may receive information from application 218 that includes instructions for outputting (e.g., displaying) an initial interface element and further sub-elements associated with application 218.

User input detection module 222 and IE generation module 224 may include all functionality of user input module 122 and IE generation module 124, respectively, of computing device 110 of FIG. 1 and may perform similar operations as user input module 122 and IE generation module 124, respectively, for analyzing indications of user input at UID 212 and displaying interface elements associated with application 218. In some examples, user input module 222 and IE generation module 224 may execute locally (e.g., at processors 240) to provide functions associated with displaying interface elements associated with application 218. In some examples, user input module 222 and IE generation module 224 may act as an interface to a remote service accessible to computing device 210. For example, context module 222 and IE generation module 224 may each be an interface or application programming interface (API) to a remote server that analyzes indications of user input and outputs interface elements for display on computing device 210.

One or more storage components 248 within computing device 210 may store information for processing during operation of computing device 210 (e.g., computing device 210 may store data accessed by modules 218, 220, 222, and 224 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 218, 220, 222, and 224 and data store 226. Storage components 248 may include a memory configured to store data or other information associated with modules 218, 220, 222, and 224 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, sound card, video graphics adapter card, speaker, cathode ray tube (CRT) monitor, liquid crystal display (LCD), or any other type of device for generating output to a human or machine in a selected modality.

UID 212 of computing device 210 may be similar to UID 112 of computing device 110 and includes display component 202 and presence-sensitive input component 204. Display component 202 may be a screen at which information (e.g., a visual indication) is displayed by UID 212 while presence-sensitive input component 204 may detect an object at and/or near display component 202.

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

UID 212 of computing device 210 may detect two-dimensional and/or three-dimensional gestures as input from a user of computing device 210. For instance, a sensor of UID 212 may detect a user's movement (e.g., moving a hand, an arm, a pen, a stylus, tactile object 109, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

In accordance with the techniques described herein, IE generation unit 224 may perform API call 130A to generate, based on data set 132, a first interface element conforming to a first graphical interface modality for application 218. IE generation unit 224 may provide the interface element to UI module 220. UI module 220 may display, at display component 202, a user interface including a graphical interface element associated with application 218 on computing device 210. In the example of FIG. 2, the user interface may be a home screen generated by an operating system executing on computing device 210. UI module 220 may receive instructions from an operating system of computing device 210 that cause UI module 220 to output user interface 202 for display at UID 212. In the example of FIG. 2, application 218 may be an application for streaming music.

An interface element (which may also be referred to as a “graphical element” or “graphical interface element”) may be provided as any feature displayed on display component 202 with which a user may interact to indicate a desire for a limited representation of an application (e.g., application 218) to be displayed on the device. The interface element may take the form of an icon, an application icon, a shortcut icon, a logo, a box, a window, a bar, or any shape. The interface element may be static and unchanging, or may move around the display, change shape or size, and/or change an image, text, or color displayed.

In some instances, the interface element may be in a static state (e.g., simple tapping inputs will open application 218 rather than expand the interface element). UI module 220 may receive an indication of an initial user input detected at an area of presence-sensitive input component 204 that corresponds to a location of display component 202 at which the interface element in the graphical user interface is displayed. UI module 220 may determine that the initial user input satisfies an input requirement, such as a length of time for the input or a pressure threshold. Responsive to determining that the initial user input satisfies the input requirement, UI module 220 may switch the state of the interface element from the static state to a dynamic state (e.g., corresponding to a first graphical interface modality), enabling the user to expand the interface element corresponding to a second graphical interface modality that allows display of additional sub-elements.

For instance, UI module 220 may receive an indication of an initial user input as a touch input held for at least a threshold amount of time. Responsive to receiving this initial user input, UI module 220 may switch the state of the interface element from the static state to a dynamic state corresponding to the first graphical interface modality. In some examples, this may be indicated by a visual alteration of the interface element. UI module 220 may then receive an indication of subsequent user input to expand the interface element, in accordance with various aspects of the techniques of this disclosure. In some instances, the subsequent user input may be entirely different actions resulting from the user lifting the tactile device away from presence-sensitive input component 204 and then placing the tactile device on or near presence-sensitive input component 204 again. In other instances, the subsequent user input may be a continuation of the original touch input.

UI module 220 may receive an indication of subsequent user input, as described above, detected at an area of presence-sensitive input component 204 at which a portion of the user interface is displayed. The user input may be a user interaction representative of an instruction to display, display component 202, a limited representation of functionality of application 218 relative to an opened state of application 218. The area of presence-sensitive input component 204 may correspond to a location of display component 202 at which the interface element in the graphical user interface is displayed, as described above.

User input module 222 may determine a characteristic of the user input. The user input received by UI module 220 may be provided by the user in a particular way (e.g., with a specific characteristic). In some examples, when the user input is a touch input, the characteristic of the user input may be an amount of pressure that the tactile device applies to presence-sensitive input component 204. In other examples, when the user input is a gesture input, the characteristic of the user input may be a direction of the swiping gesture. In still other examples, the characteristic may be a length of time that the tactile device is within a threshold distance of presence-sensitive input component 204. The characteristic may also be any combination of two or more of the above three examples. In the example of FIG. 2, the characteristic of the user input is a direction of the swiping gesture input by the tactile device.

There may be numerous characteristics of user inputs. For example, as described above, the characteristic may be a pressure, a direction of a gesture, a duration of the input, or some combination of the three. In examples where the characteristic is a pressure, the first characteristic may be a first range of pressures, and the second characteristic may be a second range of pressures, with the pressures in the second range of pressures being greater than the pressures in the first range of pressures. In examples where the characteristic is a duration of the input, the first characteristic may be a first range of times, and the second characteristic may be a second range of times, with the various times in the second range of times being greater than the various times in the second range of times.

User input detection module 222 may determine whether the characteristic of the user input is a first characteristic, a second characteristic different than the first characteristic, or even some other characteristic different from the first and second characteristics. For example, where the characteristic is a direction of a gesture, the first characteristic may be a substantially horizontal gesture (e.g., the change in X coordinates along the gesture is greater than the change in Y coordinates along the gesture) and the second characteristic may be a substantially vertical gesture (e.g., the change in Y coordinates along the gesture is greater than the change in X coordinates along the gesture).

User input detection module 222 of computing device 210 may receive tactile input from a user of computing device 210 via presence-sensitive input component 204. User input detection module 222 may receive indications of the tactile input by detecting one or more gestures from a user of computing device 210 (e.g., the user touching or pointing to one or more locations of presence-sensitive input component 204 with the tactile device). For example, display component 202 may present the graphical user interface that includes graphical components of a computing platform, operating system, applications, or services executing at or accessible by computing device 210 (e.g., the interface element of music application 218). A user may interact with the graphical user interface to cause computing devices 210 to perform operations relating to a function. The user of computing device 210 may view output and provide input to presence-sensitive input component 204 using the tactile device to interact with the interface element in order to perform the techniques described herein of determining and presenting a set of sub-elements.

Presence-sensitive input component 204 of computing device 210 may detect two-dimensional and/or three-dimensional gestures as input from a user of computing device 210. For instance, a sensor of presence-sensitive input component 204 may detect a movement of the tactile device (e.g., moving a hand, an arm, a pen, a stylus, etc.) within a threshold distance of the sensor of presence-sensitive input component 204. User input detection module 222 may receive an indication of the movement from presence-sensitive input component 204 and determine a two-dimensional (horizontal and vertical movement) or three-dimensional (horizontal movement, vertical movement, and input force) vector representation of the movement of the tactile device and correlate the vector representation to a gesture input (e.g., a hand-wave, a pinch, a clap, a pen stroke, etc.) that has multiple dimensions.

For instance, presence-sensitive input component 204 may receive, with a particular force, user input at a first location of presence-sensitive input component 204 that ends at a second location of presence-sensitive input component 204. In some instances, the first location and the second location may be the same location, or the first location and the second location may be different locations. User input detection module 222 may receive an indication of such user input, including the first and second locations and the force of the input. User input detection module 222 may determine either a two-dimensional vector based on the difference between the first location of presence-sensitive input component 204 and the second location of presence-sensitive input component 204, or a three-dimensional vector based on the difference between the first location of presence-sensitive input component 204 and the second location of presence-sensitive input component 204 and the force of the input. This two-dimensional or three-dimensional vector derived by user input detection module 222 may be the determined characteristic of the user input, in accordance with various aspects of the techniques described herein.

Responsive to user input detection module 222 determining that the characteristic of the user input is the first characteristic, IE generation module 224 may perform API call 130B to generate, based on data set 132, a second interface element conforming to a second graphical interface modality for application 218. IE generation module 224 may provide the second interface element to UI module 220. UI module 220 may output, for display at display component 202, the second interface element including a first set of sub-elements in the user interface. Each sub-element in the first set of sub-elements may represent a sub-element associated with unique actions provided by application 218.

In some examples, the first set of sub-elements may include sub-elements associated with predicted actions associated with application 218, which may in this example represent a music application. In determining the first set of sub-elements, IE generation module 224 may determine a context associated with application 218. Prior to determining the context, UI module 220 may prompt the user of computing device 210 for explicit consent to grant IE generation module 224 access to the above information. For example, prior to retaining personal preference information or sending device information associated with the user of computing device 210, UI module 220 to present a user interface via UID 212 that requests a user to select a box, click a button, state a voice input, or otherwise provide a specific input to the user interface that is interpreted by computing device 210 as unambiguous, affirmative consent for IE generation module 224 to collect and make use of the user's personal preference information and the device information.

The context may include contextual information based on one or more sources. A first source may include an application usage history associated with application 218 as provided within data set 132. For instance, music application 218 may track a user's music listening habits, including artists, genres, songs, or entire playlists that the user may frequently listen to using music application 218. The listening history, and listening frequencies, may be included in the context for the example of FIG. 2, and IE generation module 224 may assign the most listened to artists, genres, songs, or playlists to respective sub-elements in the first set of sub-elements.

Another source may include a set of one or more shortcuts defined within application 218. For instance, upon opening application 218, numerous tabs or shortcut interface elements may be defined within application 218, each tab or page showing different information within application 218 (e.g., music application 218 may include tabs or pages directed to predefined playlists, browsing by genres, profile information for an account on application 218, etc.). As such, IE generation module 224 may assign one or more of the pre-defined shortcuts within application 218 to respective sub-elements in the first set of sub-elements within the generated interface element.

IE generation module 224 may reference a predetermined list of actions within data set 132. For instance, for a music streaming application, predefined actions could include a play/pause action, a song skip action, a shuffle action, a repeat action, or any other action that may be performed within a music streaming service. As such, IE generation module 224 may assign one or more of the predetermined actions for application 218 to respective sub-elements in the first set of sub-elements set forth in data set 132.

Another source may include a current background task being performed by application 218. For instance, even though the graphical user interface may not be displayed for application 218, application 218 may be executing as a background process while computing device 210 actively executes other applications or the operating system itself. With a music streaming application, the music may continue to stream to computing device 210 even though the user may not be currently viewing a graphical user interface of application 218. As such, IE generation module 224 may assign one or more of the predetermined actions listed above within application 218 to respective sub-elements in the first set of sub-elements within the generated interface element, where the predetermined actions would affect the background task being performed by application 218.

IE generation module 224 may also reference actions associated with the interface element. For instance, aspects of the interface element may be interchangeable, such as information included in the interface element, a color of the interface element, or a logo of the interface element, each of which represent examples of information stored to data set 132. Further, sub-elements themselves may become interface elements, as described below. When an interface element comprises an action sub-element to play a song by a particular artist, IE generation module 224 may further determine the user's most played songs by the particular artist based on data set 132. Any of this information stored to data set 132 may be further utilized by IE generation module 224 in determining the first set of sub-elements.

Another source may include a current time. IE generation module 224 may alter the sub-elements that are output for display based on the time of day. For instance, with the example of a music streaming application, during the morning, the user may prefer listening to soft, upbeat music. During the day, the user may prefer listening to classical music. Finally, during the night, the user may prefer listening to either loud, fast music during the weekends or soft, slow music during the weeknights. IE generation module 224 may utilize this information in determining which sub-elements (e.g., which genres, artists, songs, etc.) to include in the first set of sub-elements of the interface element.

Yet another source may include a current location. For instance, when application 218 represents a weather application, action module 224 may determine an hourly forecast for the user's current location and output each hour's forecast as a separate sub-element.

Another source may include calendar data. For instance, when application 218 represents a navigation application, IE generation module 224 may access calendar data stored on computing device 210 or a server operatively connected to computing device 10 to determine a location of the user's next appointments. IE generation module 224 may assign locations of the user's next appointments as the action sub-elements of the first set of action sub-elements of the interface element, where selecting the sub-element will navigate the user to the respective location

Yet another source may include message data. For instance, when application 218 represents a text messaging application, IE generation module 224 may determine which contacts the user communicates with most often or most recently from data set 132. As such, action module 224 may assign one or more of these contacts to respective sub-elements in the first set of sub-elements of the interface element.

After receiving explicit consent to do so, and based on this determined context, IE generation module 224 may determine one or more predicted actions that the user of computing device 210 may wish to perform in application 218. IE generation module 224 may generate a respective sub-element for the interface element to be displayed in the graphical user interface based on these predicted actions. In other examples, the first set of sub-elements may be one or more sub-elements associated with a first account for application 218.

For instance, based on user input detection module 222 determining that the gesture input is a substantially horizontal gesture (e.g., the two-dimensional or three-dimensional vector comprises a high change in horizontal location and a low or zero change in vertical location on UID 212), IE generation module 224 may analyze an application usage history associated with application 218 to determine the most accessed playlists for the user's account on application 218. IE generation module 224 may represent the playlist accessed most often via application 218 with a first sub-element, and IE generation module 224 may represent the playlist accessed the second most often via application 218 with a second sub-element. IE generation module 224 may then generate the interface element to include the first and second sub-elements.

Presence-sensitive input component 204 and UI module 220 may receive future indications of user input selecting one of the sub-elements of the interface element. Selecting one of these sub-elements may launch application 218 and load the respective playlist within application 218, or may automatically play songs from the respective playlist without navigating the graphical user interface to application 218.

In some examples, responsive to outputting the first set of sub-elements, UI module 220 may further receive an indication of second user input detected at a second area of presence-sensitive input component 204. The second area of presence-sensitive input component 204 may correspond to a location of display component 202 at which a first sub-element of the first set of sub-elements in the interface element of the graphical user interface is displayed. UI module 220 may further output, for display at display component 202, a second interface element in the graphical user interface. The second interface element may be associated with the first sub-element.

For instance, a first action sub-element of the first set of action sub-elements in the interface element may be a specific playlist that computing device 210 may access on application 218. Computing device 210 may receive an indication of user input on the action sub-element, such as a dragging input starting at the action sub-element and ending at a location on the home screen of the graphical user interface. In doing so, UI module 220 may create a static interface element within the graphical user interface outside of the initially expanded interface element, where the user may quickly access the desired playlist without repeating the process of expanding the initial interface element.

When the new static interface element is created based on an action sub-element, the new interface element may be further expanded to display even more information of data set 132 regarding the action sub-element. For instance, UI module 220 may receive an indication of third user input detected at a third area of presence-sensitive input component 204. The third area of presence-sensitive input component 204 may correspond to a location of display component 202 at which the new interface element in the graphical user interface is displayed. User input detection module 222 may determine a characteristic of the third user input and determine whether the characteristic of the third user input is the first characteristic or the second characteristic.

Responsive to determining that the characteristic of the third user input is the first characteristic, user input detection module 222 may invoke IE generation module 224. IE generation module 224 may perform API call 130C to generate, based on data set 132, another interface element conforming to a different graphical output modality that include a third set of sub-elements. IE generation module 224 may output the newly generated interface element to UI module 220. UI module 220 may output, for display at display component 220, the newly generated interface element including the third set of sub-elements.

Conversely, responsive to determining that the characteristic of the third user input is the second characteristic, IE generation module 224 may perform API call 130D to generate, based on data set 132 (which is the same data set 132 upon which API calls 130A-130C were performed), a fourth interface element conforming to a different graphical interface modality that includes a fourth set of sub-elements different from the third set of sub-elements. IE generation module 224 may pass the fourth interface element to UI module 220. UI module 220 may output, for display at display component 202, a fourth set of sub-elements different from the third set of sub-elements. Each sub-element in the third set of sub-elements and each sub-element in the fourth set of sub-elements is associated with actions provided by the application.

For instance, in the example where the first sub-element is associated with a particular playlist on application 218, the third set of sub-elements may include the most frequently listened to songs within the playlist. Similarly, the fourth set of sub-elements may include notifications regarding the availability of any songs within the playlist, any updates made to the playlist, or any other notification data associated with the playlist.

Responsive to user input detection module 222 determining that the characteristic of the user input is the second characteristic (e.g., the two-dimensional or three-dimensional vector comprises a high change in vertical location and a low change (where a low or zero change may include no change) in horizontal location on UID 212), user input detection module 222 may invoke IE generation module 224 passing an indication of the detected gesture (or, in other words, the second characteristic). IE generation module 224 may perform API call 130B to generate, based on data set 132, the second interface element conforming to a different graphical output modality that includes the second set of sub-elements. IE generation module 224 may interface with UI module 220 to pass the second interface element. UI module 220 may output, for display at display component 202, the second interface element. Each sub-element in the second set of sub-elements is associated with unique (or non-unique) actions provided by application 218.

In some examples, the second set of sub-elements may include sub-elements associated with notification actions provided by application 218. In determining the second set of sub-elements, IE generation module 224 may determine one or more notification actions associated with application 218 using an operating system executing on computing device 210. For instance, computing device 210 may receive notification data from a server associated with application 218. Computing device 210 may utilize the operating system to manage the received notification data, including arranging the notification data in a way that is easily accessible by the user of computing device 210. Based on this notification data, IE generation module 224 may generate a respective sub-element in the interface element of the user interface based on these predicted actions. These sub-elements may be updated based on newly received notification data.

For instance, after outputting the second set of sub-elements, computing device 210 may receive additional notification data associated with application 218. Computing device 210 may invoke, responsive to receiving the additional notification data, IE generation module 224, which may determine additional notification actions associated with application 218 and the additional notification data and perform API call 130C to generate, based on data set 132, a new interface element conforming to a different graphical interface modality that includes a third set of interface sub-elements, with each interface sub-element in the third set of interface sub-elements being an interface element associated with the newly received notification data. In other examples, the second set of interface sub-elements may be a set of interface sub-elements associated with a second account for application 218 different from the first account associated with the first set of interface sub-elements.

As one example, based on user input detection module 222 determining that the user input is a substantially vertical gesture, user input detection module 222 may invoke IE generation module 224, passing an indication of the vertical gesture. IE generation module 224 may perform another one of API calls 130A-130D (“API calls 130” or “API 130”) to generate a new interface element that conforms to a different graphical interface modality. Prior to performing the one of API calls 130, IE generation module 224 may determine any news regarding new artists associated with genres that the user frequently listens to, new songs by artists that the user frequently listens to, or songs that are no longer available for streaming using application 218, updating data set 132 to reflect the determinations.

IE generation module 224 may perform the one of API calls 130 to generate, based on updated data set 132, an interface element that conforms with a different graphical interface modality that includes interface sub-elements that represent a first new artist available for streaming via application 218, a second interface sub-element that represents a second new artist available for streaming via application 218, a third interface sub-element that represents a new album available for streaming via application 218 by one of the user's favorite artists, and a forth interface sub-element that represents a notification that a particular song that the user has previously streamed via application 218 is no longer available. IE generation module 224 may interface (possibly via an API) with UI module 220 to output the new interface element via display component 202.

Presence-sensitive input component 204 and UI module 220 may receive future indications of user input selecting one of the second set of interface sub-elements. Selecting one of these interface sub-elements may launch application 218 and present a graphical user interface of application 218 that includes an interface for playing the newly available music or for displaying information as to why the song is no longer available for streaming.

In some examples, user input detection module 222 may further determine whether the characteristic of the user input is a third characteristic. Responsive to determining that the characteristic of the user input is the third characteristic, UI module 220 may invoke IE generation module 224, passing an indication of the third characteristic to IE generation module 224.

IE generation module 224 may perform one of API calls 130 to generate, based on data set 132, an interface element that includes both the first set of sub-elements and the second set of sub-elements in accordance with a different graphical interface modality (of the plurality of different graphical interface modalities). IE generation module 224 may interface with UI module 220 to display the newly generated interface element via display component 202.

In some instances, the first characteristic may be a first pressure threshold, the second characteristic may be a second pressure threshold greater than the first pressure threshold, and the third characteristic may be a third pressure threshold even greater than the second pressure threshold. In other instances, the first characteristic may be a horizontal gesture, the second characteristic may be a vertical gesture, and the third characteristic may be a diagonal gesture.

The ultimate size of the expanded interface element may be based on a termination point of the input. In other words, the interface element may have a dynamic size in its display, expanding to the termination point. For instance, user input detection module 220 may determine, based on the indication of user input, the termination point on presence-sensitive input component for the indication of user input. User input detection module 220 may then interface with IE generation module 224 and pass the termination point to IE generation module 224. IE generation module 224 may perform one of API calls 130 to generate, based on data set 132 (which may be updated to include the termination point), a new interface element corresponding to a different graphical interface modality.

IE generation module 224 interface with UI module 220 to output, for display at display component 202, an expanded interface element extending from the original interface element to an area in the graphical user interface corresponding to the termination point, where the expanded interface element includes the interface element and the respective set of interface sub-elements that are displayed based on the determined characteristic of the user input.

In general, the techniques described herein expand the ways in which a user can operate or interact with application 218 on computing device 210 without actually opening application 218 (typically done by tapping on what is otherwise typically a static, representational interface element). In particular, user interactions with an interface element for application 218 may open up limited representations (visualizations or realizations or views) of application 218, to allow the user to view specific interface sub-elements from application 218. In other words, the expanded view may include one or more information sub-elements which allow application data to be viewed without opening application 218, and/or one or more sub-elements which allow an application function to be initiated without application 218 being open. The limited representation of functionality of the application relative to an open state of the application may include interface element that conform to one or more graphical interface modalities, such as one or more of a widget, a notification, a bubble, a card, an automotive card, and a longpress menu.

An example of the foregoing would be for a user to touch and drag an interface element to open up a widget which displays information or actions via interface sub-elements associated with application 218 represented by the interface element. Alternatively, a longpress on the interface element may open up an interface element that includes a set of menu items (e.g., with each menu item in the set represented by interface sub-elements). Depending on how far the interface element is dragged, or the level of pressure applied to presence-sensitive input component 204, the size of the interface element (e.g., widget or menu items may be varied), with additional information and/or action sub-elements being displayed with an increasing extent of user interaction with the interface element.

Once the information and/or action sub-elements are displayed following the user interaction with the interface element, the user may select one of the interface sub-elements to open application 218 and view the information in more detail or perform the action desired. Alternatively, the user may tap and drag a sub-element out of the limited representation displayed and create a new interface element representing that particular interface sub-element (where this new interface element may be separate, distinct or different than the interface element including the previous sub-element). A user may then interact with the new interface element in the same way as for the original interface element to transition the interface element between interface elements conforming to different graphical interface modalities ((by performing additional ones of API calls 130 based on the same data set 132). Sub-element may then be generated out of the information and/or action sub-elements displayed in association with the new sub-elements, and so on, continually. This functionality may be provided by a single application-programming interface (API) into the system, using a structured data set which is common for all of the different graphical output modalities.

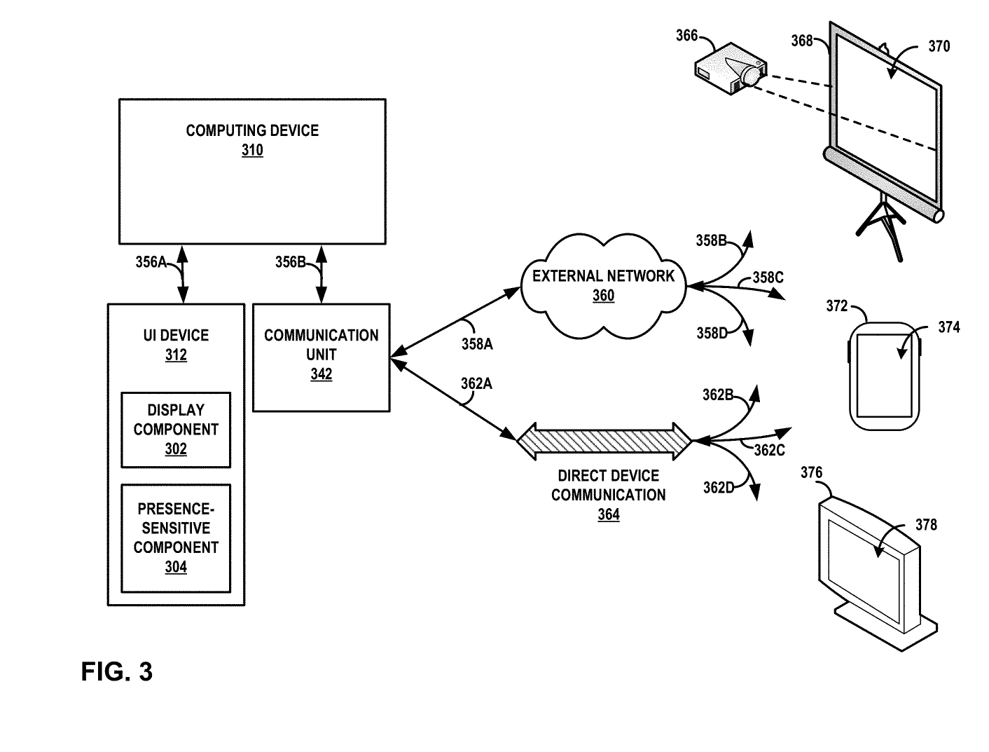

FIG. 3 is a block diagram illustrating an example system that includes a computing device that outputs screen content for display at a remote device, in accordance with one or more techniques of the present disclosure. Screen content, generally, may include any visual information that may be output for display, such as text, images, a group of moving images, etc. The example shown in FIG. 3 includes a computing device 310, display component 302, communication unit 342, projector 366, projector screen 368, mobile device 372, and visual display component 376. Although shown for purposes of example in FIGS. 1 and 2 as a stand-alone computing device 310, a computing device such as computing device 310 may, generally, be any component or system that includes a processor or other suitable computing environment for executing software instructions and, for example, need not include a display component.

As shown in the example of FIG. 3, computing device 310 may be a processor that includes functionality as described with respect to modules 220, 222, and 224 in FIG. 2. In such examples, computing device 310 may be operatively coupled to display component 302 by a communication channel 356A, which may be a system bus or other suitable connection. Computing device 310 may also be operatively coupled to communication unit 342, further described below, by a communication channel 356B, which may also be a system bus or other suitable connection. Although shown separately as an example in FIG. 3, computing device 310 may be operatively coupled to display component 302 and communication unit 342 by any number of one or more communication channels.

In other examples, such as illustrated previously by computing device 110 in FIG. 1 and computing device 210 in FIG. 2, a computing device may refer to a portable or mobile device such as a mobile phone (including smart phone), laptop computer, smartwatch, etc. In some examples, a computing device may be a desktop computer, tablet computer, smart television platform, gaming console, remote controller, electronic camera, personal digital assistant (PDA), server, mainframe, etc.

UID 312 may include display component 302 and presence-sensitive input component 304. Display component 302 may, for example, receive data from computing device 310 and display the screen content. In some examples, presence-sensitive input component 304 may determine one or more user inputs (e.g., continuous gestures, multi-touch gestures, single-touch gestures, etc.) at display component 302 using capacitive, inductive, and/or optical recognition techniques and send indications of such user input to computing device 310 using communication channel 356A. In some examples, presence-sensitive input component 304 may be physically positioned on top of display component 302 such that, when a user positions an input unit over an interface element displayed by display component 302, the location at which presence-sensitive input component 304 corresponds to the location of display component 302 at which the interface element is displayed. In other examples, presence-sensitive input component 304 may be positioned physically apart from display component 302, and locations of presence-sensitive input component 304 may correspond to locations of display component 302, such that input can be made at presence-sensitive input component 304 for interacting with interface elements displayed at corresponding locations of display component 302.

As shown in FIG. 3, computing device 310 may also include and/or be operatively coupled with communication unit 342. Communication unit 342 may include functionality of communication unit 342 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 310 may also include and/or be operatively coupled with one or more other devices, e.g., input components, output components, memory, storage devices, etc. that are not shown in FIG. 3 for purposes of brevity and illustration.

FIG. 3 also illustrates a projector 366 and projector screen 368. Other such examples of projection devices may include electronic whiteboards, holographic display components, and any other suitable devices for displaying screen content. Projector 366 and projector screen 368 may include one or more communication units that enable the respective devices to communicate with computing device 310. In some examples, the one or more communication units may enable communication between projector 366 and projector screen 368. Projector 366 may receive data from computing device 310 that includes screen content. Projector 366, in response to receiving the data, may project the screen content onto projector screen 368. In some examples, projector 366 may determine one or more user inputs (e.g., continuous gestures, multi-touch gestures, single-touch gestures, etc.) at projector screen using optical recognition or other suitable techniques and send indications of such user input using one or more communication units to computing device 310. In such examples, projector screen 368 may be unnecessary, and projector 366 may project screen content on any suitable medium and detect one or more user inputs using optical recognition or other such suitable techniques.

Projector screen 368, in some examples, may include a presence-sensitive display 370. Presence-sensitive display 370 may include a subset of functionality or all of the functionality of display component 302 as described in this disclosure. In some examples, presence-sensitive display 370 may include additional functionality. Projector screen 368 (e.g., an electronic whiteboard), may receive data from computing device 310 and display the screen content. In some examples, presence-sensitive display 370 may determine one or more user inputs (e.g., continuous gestures, multi-touch gestures, single-touch gestures, etc.) at projector screen 368 using capacitive, inductive, and/or optical recognition techniques and send indications of such user input using one or more communication units to computing device 310.

FIG. 3 also illustrates mobile device 372 and visual display component 376. Mobile device 372 and visual display component 376 may each include computing and connectivity capabilities. Examples of mobile device 372 may include e-reader devices, convertible notebook devices, hybrid slate devices, etc. Examples of visual display component 376 may include other semi-stationary devices such as televisions, computer monitors, etc. As shown in FIG. 3, mobile device 372 may include a presence-sensitive display 374. Visual display component 376 may include a presence-sensitive display 378. Presence-sensitive displays 374, 378 may include a subset of functionality or all of the functionality of display component 302 as described in this disclosure. In some examples, presence-sensitive displays 374, 378 may include additional functionality. In any case, presence-sensitive display 374, for example, may receive data from computing device 310 and display the screen content. In some examples, presence-sensitive display 378 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 310.

As described above, in some examples, computing device 310 may output screen content for display at display component 302 that is coupled to computing device 310 by a system bus or other suitable communication channel. Computing device 310 may also output screen content for display at one or more remote devices, such as projector 366, projector screen 368, mobile device 372, and visual display component 376. For instance, computing device 310 may execute one or more instructions to generate and/or modify screen content in accordance with techniques of the present disclosure. Computing device 310 may output the data that includes the screen content to a communication unit of computing device 310, such as communication unit 342. Communication unit 342 may send the data to one or more of the remote devices, such as projector 366, projector screen 368, mobile device 372, and/or visual display component 376. In this way, computing device 310 may output the screen content for display at one or more of the remote devices. In some examples, one or more of the remote devices may output the screen content at a display component that is included in and/or operatively coupled to the respective remote devices.

In some examples, computing device 310 may not output screen content at display component 302 that is operatively coupled to computing device 310. In other examples, computing device 310 may output screen content for display at both a display component 302 that is coupled to computing device 310 by communication channel 356A, and at one or more remote devices. In such examples, the screen content may be displayed substantially contemporaneously at each respective device. For instance, some delay may be introduced by the communication latency to send the data that includes the screen content to the remote device. In some examples, screen content generated by computing device 310 and output for display at display component 302 may be different than screen content display output for display at one or more remote devices.

Computing device 310 may send and receive data using any suitable communication techniques. For example, computing device 310 may be operatively coupled to external network 360 using network link 358A. Each of the remote devices illustrated in FIG. 3 may be operatively coupled to external network 360 by one of respective network links 358B, 358C, and 358D. External network 360 may include network hubs, network switches, network routers, etc., that are operatively inter-coupled thereby providing for the exchange of information between computing device 310 and the remote devices illustrated in FIG. 3. In some examples, network links 358A-358D may be Ethernet, ATM or other network connections. Such connections may be wireless and/or wired connections.

In some examples, computing device 310 may be operatively coupled to one or more of the remote devices included in FIG. 3 using direct device communication 364. Direct device communication 364 may include communications through which computing device 310 sends and receives data directly with a remote device, using wired or wireless communication. That is, in some examples of direct device communication 364, data sent by computing device 310 may not be forwarded by one or more additional devices before being received at the remote device, and vice-versa. Examples of direct device communication 364 may include Bluetooth, Near-Field Communication, Universal Serial Bus, Wi-Fi, infrared, etc. One or more of the remote devices illustrated in FIG. 3 may be operatively coupled with computing device 310 by communication links 362A-362D. In some examples, communication links 362A-362D may be connections using Bluetooth, Near-Field Communication, Universal Serial Bus, infrared, etc. Such connections may be wireless and/or wired connections.

As discussed above, after receiving explicit consent to determine a context of computing device 310 and an application executing on computing device 310, computing device 310 may receive an indication of user input detected at an area of presence-sensitive input component 304. The area of presence-sensitive input component 304 corresponds to a location of one of projector 366, projector screen 368, mobile device 372, and visual display component 376 at which an interface element in a graphical user interface is displayed. Computing device 310 may determine a characteristic of the user input. Computing device 310 may determine whether the characteristic of the user input is a first characteristic or a second characteristic different than the first characteristic. Responsive to determining that the characteristic of the user input is the first characteristic, computing device 310 may output, for display at one of projector 366, projector screen 368, mobile device 372, and visual display component 376, a first set of sub-elements. Conversely, responsive to determining that the characteristic of the user input is the second characteristic, computing device 310 may output, for display at one of projector 366, projector screen 368, mobile device 372, and visual display component 376, a second set of sub-elements different from the first set of sub-elements. Each sub-element in the first set of sub-elements and each sub-element in the second set of sub-elements is associated with unique actions associated with the application.

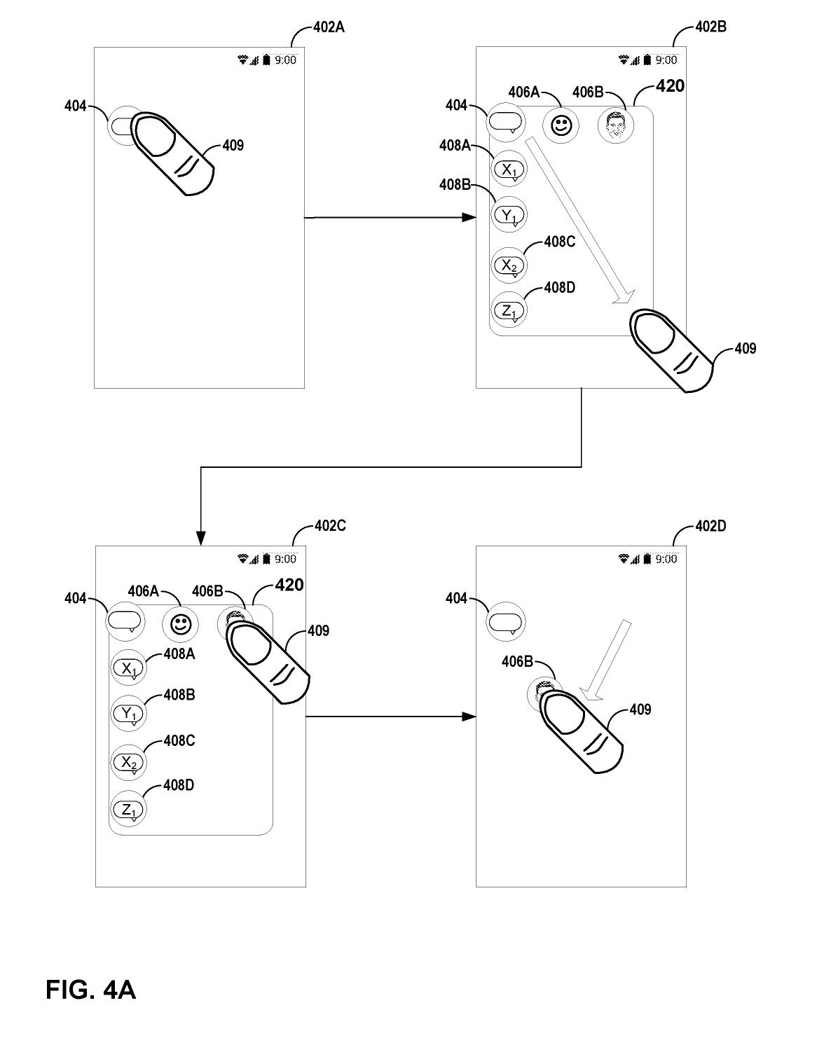

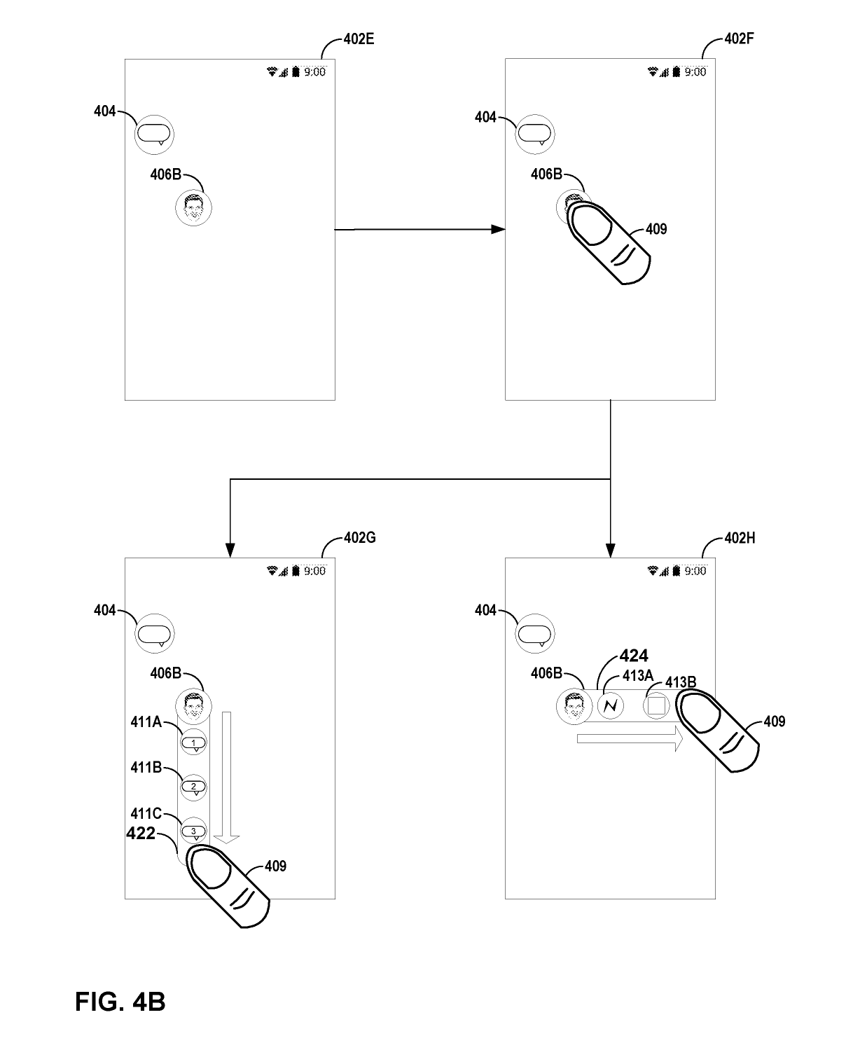

FIGS. 4A-4B are conceptual diagrams illustrating a sequence of operations for an example computing device configured to determine a characteristic of received user input and output a corresponding set of sub-elements associated with an application on the computing device in accordance with one or more aspects of the techniques set forth in this disclosure. FIGS. 4A and 4B are described below in the context of computing device 110 of FIG. 1. For example, computing device 110, while executing at one or more processors of computing device 110, may execute instructions to perform techniques in accordance with one or more aspects of the techniques set forth in this disclosure. For purposes of illustration only, FIGS. 4A and 4B are described below within the context of computing device 110 of FIG. 1.

In the example of FIG. 4A, computing device 110 may initially output graphical user interface 402A on a user interface device (UID). In the example of FIG. 4A, graphical user interface 402A includes interface element 404. Interface element 404 is associated with a text messaging application and conforms to a first graphical interface modality (e.g., an icon).

To generate interface element 404, IE generation module 124 may perform API call 130A. IE generation module 124 may perform API call 130A such that API call 130A includes a reference to common data set 132 (e.g., by passing in variables or other data components of data set 132 or pointers to data set 132). IE generation module 124 may, after generating interface element 404, invoke UI module 120, passing the generated interface element to UI module 120. UI module 120 may interface with UID 112 to present graphical user interface 402A such that graphical user interface 402A includes interface element 404.

The user of computing device 110 may utilize tactile device 409 to interact with computing device 110 and graphical user interface 402A. In the example of FIG. 4A, tactile device 409 may apply pressure to the UID at a location corresponding to an area of graphical user interface 402A where interface element 404 is displayed. The user may then drag tactile device 409 diagonally across the UID and lift tactile device 409 away from the UID to complete the user input.

UI module 120 may receive (or, in some examples, retrieve) data indicative of the user input and determine a characteristic of the user input received from tactile device 409. In the example of FIG. 4A, the characteristic may be a direction of the user input (which may be indicative of a gesture or other type of user input).

When user input detection module 122 determines the characteristic to be a substantially horizontal direction, user input detection module 122 may invoke IE generation module 124, passing an indication of the determined substantially horizontal characteristic to IE generation module 124. Based on the determined substantially horizontal characteristic, IE generation module 124 may perform one of API calls 130 to generate, based on data set 132, an interface element conforming to a different graphical output modality that includes interface sub-elements.

IE generation module 124 may interface with UI module 120 to output, for display at UID 112, interface element 404 that includes interface sub-elements 406A and 406B associated with the text messaging application. Interface sub-elements 406A-406B may each represent an action sub-element associated with a predicted action that the user may wish to perform using text messaging application 118, such as a prediction of the top two contacts to which that user may wish to send a text message.

When user input detection module 122 instead determines the characteristic to be a substantially vertical direction, user input detection module 122 may invoke IE generation module 124, passing an indication of the determined substantially vertical characteristic to IE generation module 124. Based on the determined substantially vertical characteristic, IE generation module 124 may perform one of API calls 130 to generate, based on data set 132, an interface element conforming to a different graphical output modality that includes interface sub-elements.

IE generation module 124 may interface with UI module 120 to output, for display at UID 112, interface sub-elements 408A-408D associated with text messaging application 118. Interface sub-elements 408A-408D may each represent a notification action, or notification data received by computing device 110 that computing device 110 has yet to receive an interaction for within the text messaging application.

User input detection module 122 may further determine that the characteristic is a third characteristic different from both the substantially horizontal direction and the substantially vertical direction. Instead, user input detection module 122 may determine that the characteristic is a substantially diagonal direction. In this instance, user input detection module 122 may invoke IE generation module 124, passing an indication of the third substantially diagonal direction characteristic. IE generation module 124 may perform one of API calls 130 associated with the substantially diagonal direction characteristic to generate, based on data set 132, interface element 420 conforming to a different graphical interface modality including sub-elements 406, 406B and 408A-408D.

IE generation module 124 may interface with UI module 120 to output interface element 420 that includes sub-elements 406A-406B and sub-elements 408A-408D for display at UID 112 in graphical user interface 402B. Interface element 420 that includes sub-elements 406A-406B and sub-elements 408A-408D may be sized based on the location at which tactile device 409 no longer has contact with UID 112, ending the user input.

In the example of FIG. 4A and graphical user interface 402C, the user may again use tactile device to interact with an element within graphical user interface 402C, specifically sub-element 406B. Sub-element 406B may represent a an interface sub-element that, when selected (e.g., with a tapping input), automatically opens text messaging application 118 such that text messaging application 118 presents an application-specific graphical user interface in which the user may view the most recent conversations had with the specific contact associated with sub-element 406B using text messaging application 118.

In another instance, tactile device 409 may initially apply pressure to UID 112 at a location corresponding to an area of graphical user interface 402C where sub-element 406B is displayed and then slide across the UID to a different location before discontinuing contact with UID 112. User input detection module 122 may receive data indicative of the user input, and determine a characteristic of the user input indicative of the combined selection-swiping gesture. User input detection module 122 may, after detecting the combined selection-swiping gesture, invoke IE generation module 124, passing an indication of the combined selection-swiping gesture to IE generation module 124.

IE generation module 124 may then select one of API calls 130 based on the combined selection-swiping gesture. In other words, IE generation module 124 may include selection control logic (e.g., in the form of a switch statement or a series of if-else statements) associating each characteristic, gesture, and/or detected and classified user input with a different one of API calls 130. Each of API calls 130 may reference the same data set, i.e., data set 132 shown in the example of FIG. 1. IE generation module 124 may perform one of API calls 130 associated with the selected characteristic, gesture, and/or detected and classified user input to generate, based on data set 132, interface element 406B conforming to a different graphical output modality (which is different in this instance in terms of the image displayed and potentially the action performed when selected).

Responsive to receiving such user input, IE generation module 124 may interface with UI module 120 to output interface element 406B as a portion of graphical user interface 402D, which consists of the original graphical user interface prior to expanding interface element 404, but with the addition of sub-element 406B at a location corresponding to the location where tactile device 409 discontinues contact with UID 112.

As a result, in the example of FIG. 4B, computing device 110 may output graphical user interface 402E, which includes interface element 404 and interface element 406B. In accordance with the techniques of this disclosure, computing device 110 may facilitate the same functionality with interface element 406B as computing device 110 facilitates with interface element 404. In other words, computing device 110 may enable interface element 406B to be expanded to show even further or more specific actions related to interface element 406B.

For instance, tactile device 409 may initially apply pressure to UID 112 at a location corresponding to an area of graphical user interface 402F where sub-element 406B is displayed. Tactile device 409 may complete the user input by sliding across the UID. User input detection module 122 receive data indicative of the user input and analyze the data to determine a characteristic of the additional user input received from tactile device 409. In the example of FIG. 4B, the characteristic may be a direction of the user input.

When user input detection module 122 determines the characteristic to be a substantially vertical direction, user input detection module 122 may invoke IE generation module 124, passing an indication of the determined substantially vertical characteristic to IE generation module 124. Based on the determined substantially vertical characteristic, IE generation module 124 may select one of API calls 130 associated with the determined characteristic. IE generation module 124 may next perform the selected one of API calls 130 to generate, based on data set 132, interface element 422 conforming to a different graphical output modality (i.e., a vertical widget shown in the example of FIG. 4B) that includes interface sub-elements 406B and 411A-411C.

IE generation module 124 may interface with UI module 120 to output, for display at UID 112, interface element 422 that includes sub-elements 406B and sub-elements 411A-411C associated with interface element 406B, as shown in graphical user interface 402G. In other words, computing device 110 may perform one of API calls 130, based on common data set 132, to transition interface element 406B from a first graphical interface modality (i.e., an icon as shown in the example of FIG. 4B) to interface element 422 conforming to a second graphical interface modality (i.e., a widget as shown in the example of FIG. 4B). Although not shown in the example of FIG. 4B, the transition from interface element 406B to interface element 422 may occur such that interface element 422 replaces interface element 406B.

As such, the techniques may allow computing device 110 to transition interface elements between different graphical interface modalities. The techniques may allow such seamless transitioning as a result of allowing all of API calls 130 to access the same data set, i.e., data set 132 shown in the example of FIG. 1. Rather than require a separate data set for each of API calls 130, and thereby force software developers to maintain distinct and separate data sets for each interface element conforming to a different graphical interface modality, the technique may allow software developers to define a single data set 132 from which all of API calls 130 draw to generate interface elements. Such streamlined data set management may allow software developers to provide increased functionality of computing device 110 that can be tailored to a user's particular context or need. Computing device 110 may thereby operate in a more granular manner that facilitates increased user interaction.

To illustrate, consider that sub-elements 411A-411C may each be associated with notification actions, or notification data received by computing device 110 that computing device 110 has yet to receive an interaction for within the text messaging application. In the example of FIG. 4B, the notification data may be limited to notification data received from the contact identified in sub-element 406B. In other instances, sub-elements 411A-411C may be the most recently received text messages sent by the contact identified by sub-element 406B and received by computing device 110 using text messaging application 118.

When user input detection module 122 determines the characteristic to be a substantially horizontal direction, user input detection module 122 may invoke IE generation module 124, passing an indication of the determined substantially horizontal characteristic to IE generation module 124. Based on the determined substantially horizontal characteristic, IE generation module 124 may perform one of API calls 130 to generate, based on data set 132, an interface element 424 conforming to a different graphical output modality that includes interface sub-elements.

IE generation module 124 may interface with UI module 120 to output, for display at UID 112, sub-elements 413A-413B associated with text messaging application 118, as shown in graphical user interface 402H. Sub-elements 413A-413B may each represent an action sub-element associated with a predicted action that the user may wish to perform using text messaging application 118 and associated with interface element 406B. For instance, selecting sub-element 413A may cause computing device 110 to open text messaging application 118 so as to allow the user to begin typing a new text message to send to the contact associated with interface element 406B. In other instances, selecting sub-element 413B may cause computing device 110 to open text messaging application 118 such that text messaging application shows contact information for the contact associated with interface element 406B.

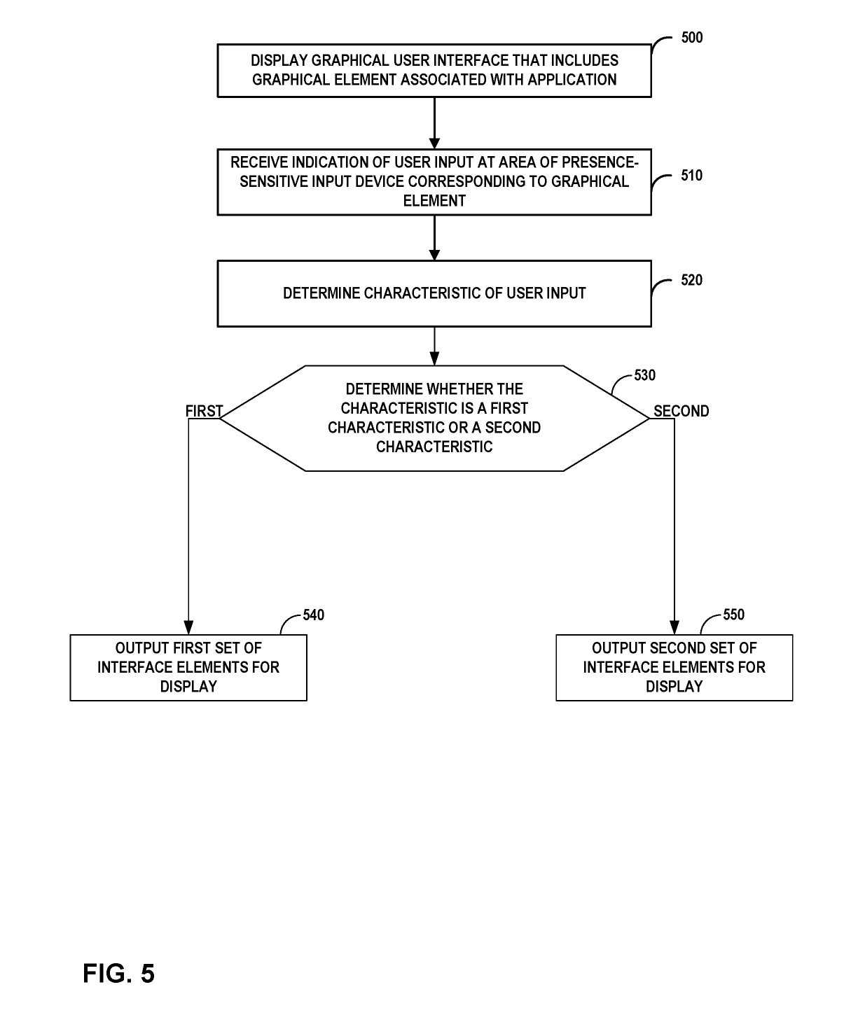

FIG. 5 is a flowchart illustrating further example operations of an example computing device configured to determine a characteristic of received user input and output a corresponding set of sub-elements associated with an application on the computing device, in accordance with various aspects of the techniques set forth in this disclosure. FIG. 5 is described below in the context of computing device 110 of FIG. 1. For example, UI module 120, gesture module 122, and action module 124, while executing at one or more processors of computing device 110, may execute instructions to perform operations 500-550, in accordance with one or more aspects of the present disclosure. For purposes of illustration only, FIG. 5 is described below within the context of computing device 110 of FIG. 1.

In accordance with the techniques described herein, UI module 120 may display, at UID 112, user interface 102A including interface element 104 associated with application 118 on computing device 110 (500). User interface 102A may be a home screen generated by an operating system executing on computing device 110. UI module 120 may receive instructions from an operating system of computing device 110 that cause UI module 120 to output user interface 102 for display at UID 112.

UI module 120 may receive an indication of user input detected at an area of UID 112 at which a portion of user interface 102A is displayed (510). The area of UID 12 may correspond to a location of UID 112 at which interface element 104 in graphical user interface 102A is displayed. For instance, the user, using tactile object 109, may interact with computing device 110 by beginning a user input with tactile object 109 at an area of UID 112 that is displaying interface element 104. In some examples, the user input may be a touch input from tactile object 109 with a particular amount of pressure.

User input detection module 122 may determine a characteristic of the user input (520). The user input received by UI module 120 may be provided by the user in a particular way (e.g., with a specific characteristic). In some examples, when the user input is a touch input, the characteristic of the user input may be an amount of pressure that tactile object 109 applies to UID 112. In other examples, when the user input is a gesture input, the characteristic of the user input may be a direction of the swiping gesture. In still other examples, the characteristic may be a length of time that tactile object 109 is within the necessary distance of UID 112. The characteristic may also be some combination of the above three examples.

There may be numerous characteristics of user inputs. For example, as described above, the characteristic may be a pressure, a direction of a gesture, a duration of the input, or some combination of the three. In examples where the characteristic is a pressure, the first characteristic may be a first range of pressures, and the second characteristic may be a second range of pressures, with the pressures in the second range of pressures being greater than the pressures in the first range of pressures. In examples where the characteristic is a duration of the input, the first characteristic may be a first range of times, and the second characteristic may be a second range of times, with the various times in the second range of times being greater than the various times in the second range of times.

User input detection module 122 may determine whether the characteristic of the user input is a first characteristic, a second characteristic different than the first characteristic, or even some other characteristic different from the first and second characteristics (530). For example, where the characteristic is a direction of a gesture, the first characteristic may be a substantially horizontal gesture (e.g., the change in X coordinates along the gesture is greater than the change in Y coordinates along the gesture) and the second characteristic may be a substantially vertical gesture (e.g., the change in Y coordinates along the gesture is greater than the change in X coordinates along the gesture).

Responsive to user input detection module 122 determining that the characteristic of the user input is the first characteristic (“FIRST” branch of 530), UI module 120 may output, for display at UID 112, a first set of interface elements 106A-106B in user interface 102B (540). Each interface element 106A and 106B in the first set of interface elements is associated with actions provided by application 118.

In some examples, the first set of interface elements may include interface elements associated with predicted actions provided by application 118. In determining the first set of interface elements, IE generation module 124 may, after receiving explicit consent to do so, determine a context associated with application 118. The context may include contextual information based on one or more of an application usage history associated with application 118, a set of one or more shortcuts defined within application 118, a predetermined list of actions, a current background task being performed by application 118, an action associated with interface element 104, a current time, a current location, calendar data, and message data. Based on this context, IE generation module 124 may determine one or more predicted actions that the user of computing device 110 may wish to perform in application 118. IE generation module 124 may generate a respective interface element 106A-106B in graphical user interface 102B based on these predicted actions.

For instance, based on user input detection module 122 determining that the user input is a substantially horizontal gesture (e.g., the two-dimensional or three-dimensional vector comprises a high change in horizontal location and a low or zero change in vertical location on UID 112), IE generation module 124 may analyze message data and an application usage history associated with application 118 to determine a group of contacts that the user contacts most often using the text message feature of application 118. IE generation module 124 may represent the user contacted most often via application 118 with interface element 106A, and IE generation module 124 may represent the user contacted the second most often via application 118 with interface element 106B. UID 112 and UI module 120 may receive future indications of user input selecting one of interface elements 106A or 106B. Selecting one of these sub-elements may launch application 118 and load a page within application 118 that includes an interface that the user may interact with to compose a message to the respective user or read previous messages sent to the respective user associated with the selection interface element 106A or 106B.

Responsive to user input detection module 122 determining that the characteristic of the user input is the second characteristic (“SECOND” branch of 530), UI module 120 may output, for display at UID 112, a second set of sub-elements 108A-108D different from the first set of sub-elements 106A-106B in user interface 102C (550). Each interface element 108A, 108B, 108C, and 108D in the second set of interface elements is associated with actions associated with application 118.

For instance, based on user input detection module 122 determining that the user input is a substantially vertical gesture, IE generation module 124 may determine the most recently received messages or a set of unread messages received using the text message feature of application 118. IE generation module 124 may represent a first unread text message received via application 118 with interface element 108A, a second unread text message received via application 118 with interface element 108B, a third unread text message received via application 118 with interface element 108C, and a most recently received text message via application 118 that has been read with interface element 108D. UID 112 and UI module 120 may receive future indications of user input selecting one of interface elements 108A-108D. Selecting one of these interface elements may launch application 118 and load a page within application 118 that includes an interface that displays the respective text message associated with the selection one of interface elements 108A-108D.

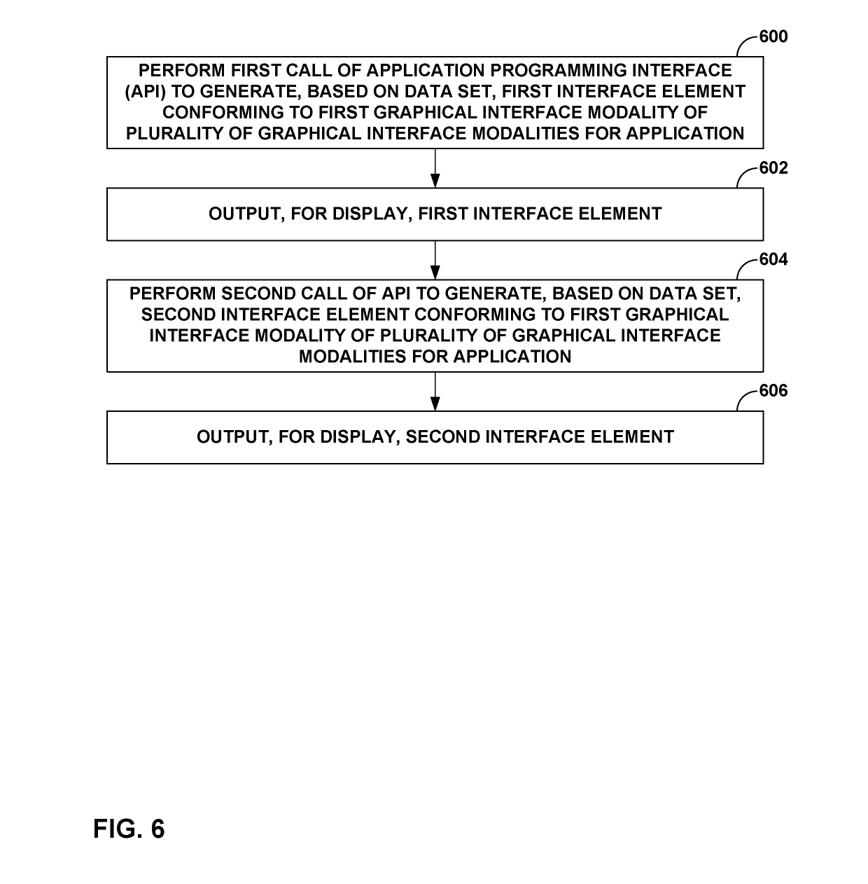

FIG. 6 is a flowchart illustrating example operation of computing device 210 in performing various aspects of the techniques described in this disclosure. In the example of FIG. 6, processors 240 may be configured to perform the operations described above with respect to UI module 220, User input detection module 222, and IE generation module 224.

Processors 240 may invoke IE generation module 224 to perform a first call of an application programming interface (API, which is shown as “API 130” in the example of FIG. 2) to generate, based on data set 132, a first interface element (e.g., interface element 404 shown in the example of FIG. 4A) conforming to a first graphical interface modality of a plurality of graphical interface modalities for application 118 (600). IE generation module 224 may interface with UI module 220 to present, for display via display component 202, the first interface element (602).

UI module 220, as executed by processors 240, may next receive indications of user input entered via presence-sensitive input components 204. UI module 220 may invoke user input detection module 220, which may analyze the indications of user input to detect one or more gestures, such as a long-press gesture, a horizontal swipe gesture (or substantially-horizontal swipe gesture), a vertical swipe gesture (or substantially-vertical swipe gesture), a diagonal swipe gesture, etc. User input detection module 22, after analyzing the user input to detect the type of gesture (or, in other words, a characteristic of the user input), invoke IE generation module 224, passing the type of gesture to IE generation module 224.

Once invoked, IE generation module 224 may select one of API calls 130 based on the characteristic of the user input. IE generation module 224 may next perform a second call of the API (e.g., one of API calls 130) to generate, based on data set 132, a second interface element (e.g., interface element 422 or 424) conforming to a second graphical modality of the plurality of graphical interface modalities for application 118 (604). IE generation module 224 may interface with UI module 220 to present, for display via display component 202, the second interface element (604).

Clause 1. A method comprising: displaying, by a computing device, at a display device, a graphical user interface including an interface element associated with an application on the computing device; receiving, by the computing device, an indication of user input detected at an area of a presence-sensitive input device, wherein the area of the presence-sensitive input device corresponds to a location of the display device at which the interface element in the graphical user interface is displayed; determining, by the computing device, a characteristic of the user input; determining, by the computing device, whether the characteristic of the user input is a first characteristic or a second characteristic different than the first characteristic; responsive to determining that the characteristic of the user input is the first characteristic, outputting, by the computing device, for display at the display device, a first set of sub-elements; and responsive to determining that the characteristic of the user input is the second characteristic, outputting, by the computing device, for display at the display device, a second set of sub-elements different from the first set of sub-elements, wherein each sub-element in the first set of sub-elements and each sub-element in the second set of sub-elements is associated with unique actions associated with the application.

Clause 2. The method of clause 1, wherein each sub-element in the first set of sub-elements comprises a respective graphical indication of a respective predicted action associated with the application.

Clause 3. The method of clause 2, wherein outputting the first set of sub-elements comprises: determining, by the computing device, a context associated with the application; determining, by the computing device, based at least in part on the context, one or more predicted actions associated with the application; and for each predicted action of the one or more predicted actions, outputting, by the computing device, for display at the display device, a graphical indication of the respective predicted action as an sub-element in the first set of sub-elements.

Clause 4. The method of any of clauses 1-3, wherein each sub-element in the second set of sub-elements comprises a respective graphical indication of a respective notification action associated with the application, wherein outputting the second set of sub-elements comprises: determining, by an operating system executing on the computing device, one or more notification actions associated with the application; and for each notification action of the one or more notification actions, outputting, by the computing device, for display at the display device, a graphical indication of the respective notification action as an sub-element in the second set of sub-elements.

Clause 5. The method of any of clauses 1-4, wherein the user input comprises a user interaction representative of an instruction to display on the display device a limited representation of functionality of the application relative to an opened state of the application.

Clause 6. The method of any of clauses 1-5, wherein determining whether the characteristic of the user input is the first characteristic or the second characteristic comprises determining, by the computing device, whether the characteristic of the user input is the first characteristic, the second characteristic, or a third characteristic different from the first characteristic and the second characteristic, and wherein the method further comprises, responsive to determining that the characteristic of the user input is the third characteristic, outputting, by the computing device, for display at the display device, the first set of sub-elements and the second set of sub-elements.

Clause 7. The method of clause 6, wherein the first characteristic comprises a first pressure threshold, wherein the second characteristic comprises a second pressure threshold greater than the first pressure threshold, and wherein the third characteristic comprises a third pressure threshold greater than the second pressure threshold.

Clause 8. The method of clause 6, wherein the first characteristic comprises a horizontal gesture, wherein the second characteristic comprises a vertical gesture, and wherein the third characteristic comprises a diagonal gesture.

Clause 9. The method of clause 8, wherein outputting a respective set of sub-elements comprises: determining, by the computing device, based on the indication of user input, a termination point on the presence-sensitive display for the indication of user input; outputting, by the computing device, for display at the display device, an expanded interface element extending from the interface element to an area in the graphical user interface corresponding to the termination point, wherein the expanded interface element includes the interface element and the respective set of sub-elements.

Clause 10. The method of any of clauses 1-9, further comprising: responsive to outputting the first set of sub-elements, receiving, by the computing device, an indication of second user input detected at a second area of the presence-sensitive input device, wherein the second area of the presence-sensitive input device corresponds to a location of the display device at which a first sub-element of the first set of sub-elements in the graphical user interface is displayed; and outputting, by the computing device, for display at the display device, a second interface element in the graphical user interface, wherein the second interface element is associated with the first sub-element.

Clause 11. The method of clause 10, further comprising: receiving, by the computing device, an indication of third user input detected at a third area of the presence-sensitive input device, wherein the third area of the presence-sensitive input device corresponds to a location of the display device at which the second interface element in the graphical user interface is displayed; determining, by the computing device, a characteristic of the third user input; determining, by the computing device, whether the characteristic of the third user input is the first characteristic or the second characteristic; responsive to determining that the characteristic of the third user input is the first characteristic, outputting, by the computing device, for display at the display device, a third set of sub-elements; and responsive to determining that the characteristic of the third user input is the second characteristic, outputting, by the computing device, for display at the display device, a fourth set of sub-elements different from the third set of sub-elements, wherein each sub-element in the third set of sub-elements and each sub-element in the fourth set of sub-elements is associated with unique actions associated with the application.

Clause 12. The method of any of clauses 1-11, wherein the first set of sub-elements comprises one or more sub-elements associated with a first account for the application, and wherein the second set of sub-elements comprises one or more sub-elements associated with a second account for the application different than the first account.

Clause 13. The method of any of clauses 1-12, wherein the user input comprises a subsequent user input, and wherein a state of the interface element comprises a static state, the method further comprising: prior to receiving the indication of the subsequent user input: receiving, by the computing device, an indication of an initial user input detected at the area of the presence-sensitive input device; determining, by the computing device, that the initial user input satisfies an input requirement; responsive to determining that the initial user input satisfies the input requirement, switching, by the computing device, the state of the interface element from the static state to a dynamic state.

Clause 14. A computing device comprising: a display device; a presence-sensitive input device; at least one processor; and a memory that stores instructions that, when executed, cause the at least one processor to: display, at the display device, a graphical user interface including an interface element associated with an application on the computing device; receive an indication of user input detected at an area of the presence-sensitive input device, wherein the area of the presence-sensitive input device corresponds to a location of the display device at which the interface element in the graphical user interface is displayed; determine a characteristic of the user input; determine whether the characteristic of the user input is a first characteristic or a second characteristic different than the first characteristic; responsive to determining that the characteristic of the user input is the first characteristic, output, for display at the display device, a first set of sub-elements; and responsive to determining that the characteristic of the user input is the second characteristic, output, for display at the display device, a second set of sub-elements different from the first set of sub-elements, wherein each sub-element in the first set of sub-elements and each sub-element in the second set of sub-elements is associated with unique actions associated with the application.

Clause 15. The computing device of clause 14, wherein each sub-element in the first set of sub-elements comprises a respective graphical indication of a respective predicted action associated with the application, and wherein the instructions that cause the at least one processor to output the first set of sub-elements comprise instructions that, when executed, cause the at least one processor to: determine a context associated with the application; determine based at least in part on the context, one or more predicted actions associated with the application; and for each predicted action of the one or more predicted actions, output, for display at the display device, a graphical indication of the respective predicted action as an sub-element in the first set of sub-elements.

Clause 16. The computing device of clause 15, wherein the context comprises contextual information based on one or more of an application usage history associated with the application, a set of one or more shortcuts defined within the application, a predetermined list of actions, a current background task being performed by the application, an action associated with the interface element, a current time, a current location, calendar data, and message data.

Clause 17. The computing device of any of clauses 14-16, wherein each sub-element in the second set of sub-elements comprises a respective graphical indication of a respective notification action associated with the application, and wherein the instructions that cause the at least one processor to output the second set of sub-elements comprise instructions that, when executed, cause the at least one processor to: determine, using an operating system executing on the computing device, one or more notification actions associated with the application; and for each notification action of the one or more notification actions, output, for display at the display device, a graphical indication of the respective notification action as an sub-element in the second set of sub-elements.

Clause 18. The computing device of clause 17, wherein the instructions, when executed, further cause the at least one processor to: after outputting the second set of sub-elements, receive additional notification data associated with the application; determine, using the operating system and based at least in part on the additional notification data, one or more additional notification actions associated with the application; and for each additional notification action of the one or more additional notification actions, output, for display at the display device, a graphical indication of the respective additional notification action as an sub-element in a third set of sub-elements, wherein each sub-element in the third set of sub-elements is associated with unique actions associated with the application.

Clause 19. A non-transitory computer-readable storage medium storing instructions that, when executed, cause at least one processor of a computing device to: display, at a display device, a graphical user interface including an interface element associated with an application on the computing device; receive an indication of user input detected at an area of a presence-sensitive input device, wherein the area of the presence-sensitive input device corresponds to a location of the display device at which the interface element in the graphical user interface is displayed; determine a characteristic of the user input; determine whether the characteristic of the user input is a first characteristic or a second characteristic different than the first characteristic; responsive to determining that the characteristic of the user input is the first characteristic, output, for display at the display device, a first set of sub-elements; and responsive to determining that the characteristic of the user input is the second characteristic, output, for display at the display device, a second set of sub-elements different from the first set of sub-elements, wherein each sub-element in the first set of sub-elements and each sub-element in the second set of sub-elements is associated with unique actions associated with the application.

Clause 20. The non-transitory computer-readable storage medium of clause 19, wherein each sub-element in the first set of sub-elements comprises a respective graphical indication of a respective predicted action associated with the application, wherein each sub-element in the second set of sub-elements comprises a respective graphical indication of a respective notification action associated with the application, wherein the instructions that cause the at least one processor to output the first set of sub-elements or the second set of sub-elements comprise instructions that, when executed, cause the at least one processor to: responsive to determining that the characteristic of the user input is the first characteristic: determine a context associated with the application, wherein the context comprises contextual information based on one or more of an application usage history associated with the application, a set of one or more shortcuts defined within the application, a predetermined list of actions, a current background task being performed by the application, an action associated with the interface element, a current time, a current location, calendar data, and message data; determine based at least in part on the context, one or more predicted actions associated with the application; and for each predicted action of the one or more predicted actions, output, for display at the display device, a graphical indication of the respective predicted action as an sub-element in the first set of sub-elements; and responsive to determining that the characteristic of the user input is the second characteristic: determine, using an operating system executing on the computing device, one or more notification actions associated with the application; and for each notification action of the one or more notification actions, output, for display at the display device, a graphical indication of the respective notification action as an sub-element in the second set of sub-elements.

Clause 21. A computing device configured to perform any of the methods of clauses 1-13.

Clause 22. A computing device comprising means for performing any of the methods of clauses 1-13.

Clause 23. A computer-readable storage medium encoded with instructions for causing one or more programmable processors to perform any of the methods or clauses 1-13.

Clause 24. A method comprising: displaying, by a computing device, at a display device, a graphical user interface including an interface element associated with an application on the computing device; receiving, by the computing device, an indication of user input detected at an area of a presence-sensitive input device, wherein the area of the presence-sensitive input device corresponds to a location of the display device at which the interface element in the graphical user interface is displayed; determining, by the computing device, a characteristic of the user input; determining, by the computing device, whether the characteristic of the user input is a first characteristic or a second characteristic different than the first characteristic; and responsive to determining that the characteristic of the user input is the first characteristic, outputting, by the computing device, for display at the display device, a first set of sub-elements.

Clause 25. The method of clause 24, wherein the user input is a first user input, the method further comprising: receiving, by the computing device, an indication of a second user input detected at the area of the presence-sensitive input device; determining, by the computing device, a characteristic of the second user input; determining, by the computing device, whether the characteristic of the second user input is the first characteristic or the second characteristic different than the first characteristic; and responsive to determining that the characteristic of the user input is the second characteristic, outputting, by the computing device, for display at the display device, a second set of sub-elements different from the first set of sub-elements, wherein each sub-element in the first set of sub-elements and each sub-element in the second set of sub-elements is associated with unique actions associated with the application.

Clause 26. A method carried out by a computing device comprising a display device, the method comprising: displaying on the display device a user interface element associated with an application which may operate on the computing device; detecting a user interaction with the user interface element, the user interaction representative of an instruction to display on the display device a limited representation of functionality of the application relative to an opened state of the application; determining whether the user interaction comprises a first interaction characteristic or a second interaction characteristic; if the user interaction is determined to comprise a first interaction characteristic, displaying on the display device a first set of interface elements representative of a first set of functions of the application; and if the user interaction is determined to comprise a second interaction characteristic, displaying on the display device a second set of interface elements representative of a second set of functions of the application.

Clause 27. The method of clause 26, wherein the user interaction with the user interface element comprises an interaction extent and the number of interface elements in the first or second set of interface elements displayed on the display device increases with increasing interaction extent.

Clause 28. The method of any of clauses 26-27, wherein the user interaction with the user interface element comprises an interaction extent and a display area for the first or second set of interface elements on the display device increases with increasing interaction extent.

Clause 29. The method of any of clauses 26-28, wherein the interface elements comprise one or more information elements which allow application data to be viewed without opening the application, and/or one or more sub-elements which allow an application function to be initiated without the application being open.

Clause 30. The method of any of clauses 26-29, wherein the user interaction with user interface element comprises a first triggering input followed by the first or second interaction characteristic.

Clause 31. The method of any of clauses 26-30, wherein the user interface element comprises an application icon for opening the application.

Clause 32. The method of any of clauses 26-31, wherein the user interface element comprises a shortcut icon for performing or interacting with a specific function of the application.

Clause 33. The method of clause 32, wherein the shortcut icon is generated from an interface element previously displayed in a set of interface elements in response to an instruction to display on the display device a limited representation of functionality of the application relative to an opened state of the application.

Clause 34. The method of any of clauses 26-33, further comprising the step of generating a second user interface element from an interface element displayed in the first or second set of interface elements.

Clause 35. The method of any of clauses 26-34, wherein the limited representation of functionality of the application relative to an open state of the application comprises one or more of a widget, a notification, a bubble, a now card, and a longpress menu.

Clause 36. A computing device configured to perform any of the methods of clauses 26-35.

Clause 37. A computing device comprising means for performing any of the methods of clauses 26-35.

Clause 38. A computer-readable storage medium encoded with instructions for causing one or more programmable processors to perform any of the methods or clauses 26-35.

Clause 39. A method comprising performing, by one or more processors of a computing device, a first call of an application programming interface (API) to generate, based on a data set, an interface element conforming to a first graphical interface modality of a plurality of graphical interface modalities for an application; outputting, by the one or more processors and for display, the first interface element; performing, by the one or more processors, a second call of the API to generate, based on the data set, a second interface element conforming to a second graphical interface modality of the plurality of graphical interface modalities for the application, the second graphical interface modality being different than the first graphical interface modality; and outputting, by the one or more processors and for display, the second interface element.

Clause 40. The method of clause 39, wherein the plurality of graphical interface modalities include two or more of: 1) an icon; 2) a long-press menu; 3) a widget; 4) a bubble; 5) a graphical card; 6) an automotive modality; and 7) a wearable modality.

Clause 41. The method of any combination of clause 39 and 40, wherein performing the second call of the API comprises performing, responsive to receiving data indicative of a user input, the second call of the API to generate, based on the data set, the second interface element conforming to the second graphical interface modality.

Clause 42. The method of clause 41, further comprising: detecting, based on the data indicative of the user input, a characteristic of the user input; and selecting the second call of the API based on the characteristic user input.

Clause 43. The method of any combination of clauses 39-42, wherein outputting the second interface element for display comprises displaying the first interface element transitioning to the second interface element.

Clause 44. The method of clause 43, wherein displaying the first interface element transitioning to the second interface element comprises displaying the first interface element transitioning to the second interface element such that the second interface element replaces the first interface element.

Clause 45. The method of any combination of clauses 39-44, wherein the second interface element comprises an extended version of the first interface element that includes interface sub-elements providing one or more of additional information and additional actions relative to the first interface element.

Clause 46. The method of any combination of clauses 39-45, wherein the data set includes data relevant to one or more sub-elements of both the first interface element and the second interface element.

Clause 47. The method of clause 46, wherein the data relevant to one or more sub-elements includes data indicative of one or more of an icon associated with each of the one or more sub-elements, an action associated with each of the one or more sub-elements, a title associated with each of the one or more sub-elements, a sub-heading associated with each of the one or more sub-elements, a caption associated with each of the one or more sub-elements, and a full description associated with each of the one or more sub-elements.

Clause 48. The method of any combination of clauses 39-47, wherein the API comprises an API provided by an operating system supporting execution of the application.

Clause 49. A device comprising: a memory configured to store a data set; one or more processors configured to perform a first call of an application programming interface (API) to generate, based on a data set, an interface element conforming to a first graphical interface modality of a plurality of graphical interface modalities for an application; and a display configured to display the first interface element, wherein the one or more processors are further configured to perform a second call of the API to generate, based on the data set, a second interface element conforming to a second graphical interface modality of the plurality of graphical interface modalities for the application, the second graphical interface modality being different than the first graphical interface modality, and wherein the display is further configured to display the second interface element.

Clause 50. The device of clause 49, wherein the plurality of graphical interface modalities include two or more of: 1) an icon; 2) a long-press menu; 3) a widget; 4) a bubble; 5) a graphical card; 6) an automotive modality; and 7) a wearable modality.

Clause 51. The device of any combination of clauses 49 and 50, wherein the one or more processors are configured to perform, responsive to receiving data indicative of a user input, the second call of the API to generate, based on the data set, the second interface element conforming to the second graphical interface modality.

Clause 52. The device of clause 51, wherein the one or more processors are further configured to: detect, based on the data indicative of the user input, a characteristic of the user input; and select the second call of the API based on the characteristic of the user input.

Clause 53. The device of any combination of clauses 49-52, wherein the display is configured to display the first interface element transitioning to the second interface element.

Clause 54. The device of clause 53, wherein the display is configured to display the first interface element transitioning to the second interface element such that the second interface element replaces the first interface element.

Clause 55. The device of any combination of clauses 49-54, wherein the second interface element comprises an extended version of the first interface element that includes interface sub-elements providing one or more of additional information and additional actions relative to the first interface element.

Clause 56. The device of any combination of clauses 49-55, wherein the data set includes data relevant to one or more sub-elements of both the first interface element and the second interface element.

Clause 57. The device of clause 56, wherein the data relevant to one or more sub-elements includes data indicative of one or more of an icon associated with each of the one or more sub-elements, an action associated with each of the one or more sub-elements, a title associated with each of the one or more sub-elements, a sub-heading associated with each of the one or more sub-elements, a caption associated with each of the one or more sub-elements, and a full description associated with each of the one or more sub-elements.

Clause 58. The device of any combination of clauses 49-57, wherein the API comprises an API provided by an operating system supporting execution of the application.

Clause 59. A non-transitory computer-readable storage medium having stored thereon instructions that, when executed, cause one or more processors to: perform a first call of an application programming interface (API) to generate, based on a data set, an interface element conforming to a first graphical interface modality of a plurality of graphical interface modalities for an application; output, for display, the first interface element; perform a second call of the API to generate, based on the data set, a second interface element conforming to a second graphical interface modality of the plurality of graphical interface modalities for the application, the second graphical interface modality being different than the first graphical interface modality; and present, for display, the second interface element.

Clause 60. The non-transitory computer-readable storage medium of clause 59, wherein the plurality of graphical interface modalities include two or more of: 1) an icon; 2) a long-press menu; 3) a widget; 4) a bubble; 5) a graphical card; 6) an automotive modality; and 7) a wearable modality.

Clause 61. The non-transitory computer-readable storage medium of any combination of clause 59 and 60 having stored thereon instructions that, when executed, cause the one or more processors to perform, responsive to receiving data indicative of a user input, the second call of the API to generate, based on the data set, the second interface element conforming to the second graphical interface modality.

Clause 62. The non-transitory computer-readable storage medium of clause 61 having stored thereon instructions that, when executed, further cause the one or more processors to detect, based on the data indicative of the user input, a characteristic of the user input; and select the second call of the API based on the characteristic user input.

Clause 63. The non-transitory computer-readable storage medium of any combination of clauses 59-62 having instructions stored thereon that, when executed, cause the one or more processor to display the first interface element transitioning to the second interface element.

Clause 64. The non-transitory computer-readable storage medium of clause 63 having stored thereon instructions that, when executed, cause the one or more processors to display the first interface element transitioning to the second interface element such that the second interface element replaces the first interface element.

Clause 65. The non-transitory computer-readable storage medium of any combination of clauses 59-64, wherein the second interface element comprises an extended version of the first interface element that includes interface sub-elements providing one or more of additional information and additional actions relative to the first interface element.

Clause 66. The non-transitory computer-readable storage medium of any combination of clauses 59-65, wherein the data set includes data relevant to one or more sub-elements of both the first interface element and the second interface element.

Clause 67. The non-transitory computer-readable storage medium of clause 66, wherein the data relevant to one or more sub-elements includes data indicative of one or more of an icon associated with each of the one or more sub-elements, an action associated with each of the one or more sub-elements, a title associated with each of the one or more sub-elements, a sub-heading associated with each of the one or more sub-elements, a caption associated with each of the one or more sub-elements, and a full description associated with each of the one or more sub-elements.

Clause 68. The non-transitory computer-readable storage medium of any combination of clauses 59-67, wherein the API comprises an API provided by an operating system supporting execution of the application.

Clause 69. An apparatus comprises: means for performing a first call of an application programming interface (API) to generate, based on a data set, an interface element conforming to a first graphical interface modality of a plurality of graphical interface modalities for an application; means for outputting, for display, the first interface element; means for performing a second call of the API to generate, based on the data set, a second interface element conforming to a second graphical interface modality of the plurality of graphical interface modalities for the application, the second graphical interface modality being different than the first graphical interface modality; and means for outputting, for display, the second interface element.

Clause 70. The apparatus of clause 69, wherein the plurality of graphical interface modalities include two or more of: 1) an icon; 2) a long-press menu; 3) a widget; 4) a bubble; 5) a graphical card; 6) an automotive modality; and 7) a wearable modality.

Clause 71. The apparatus of any combination of clause 69 and 70, wherein the means for performing the second call of the API comprises means for performing, responsive to receiving data indicative of a user input, the second call of the API to generate, based on the data set, the second interface element conforming to the second graphical interface modality.

Clause 72. The apparatus of clause 71, further comprising: means for detecting, based on the data indicative of the user input, a characteristic of the user input; and means for selecting the second call of the API based on the characteristic user input.

Clause 73. The apparatus of any combination of clauses 69-72, wherein the means for outputting the second interface element for display comprises means for displaying the first interface element transitioning to the second interface element.

Clause 74. The apparatus of clause 73, wherein the means for displaying the first interface element transitioning to the second interface element comprises means for displaying the first interface element transitioning to the second interface element such that the second interface element replaces the first interface element.

Clause 75. The apparatus of any combination of clauses 69-74, wherein the second interface element comprises an extended version of the first interface element that includes interface sub-elements providing one or more of additional information and additional actions relative to the first interface element.

Clause 76. The apparatus of any combination of clauses 69-75, wherein the data set includes data relevant to one or more sub-elements of both the first interface element and the second interface element.

Clause 77. The apparatus of clause 76, wherein the data relevant to one or more sub-elements includes data indicative of one or more of an icon associated with each of the one or more sub-elements, an action associated with each of the one or more sub-elements, a title associated with each of the one or more sub-elements, a sub-heading associated with each of the one or more sub-elements, a caption associated with each of the one or more sub-elements, and a full description associated with each of the one or more sub-elements.

Clause 78. The method of any combination of clauses 69-77, wherein the API comprises an API provided by an operating system supporting execution of the application.

Clause 79. A computing device configured to perform any of the methods of clauses 39-48.

Clause 80. A computing device comprising means for performing any of the methods of clauses 49-58.

Clause 81. A computer-readable storage medium encoded with instructions for causing one or more programmable processors to perform any of the methods or clauses 69-77.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
displaying, by a computing device, at a display device, a graphical user interface including an interface element associated with an application on the computing device;
receiving, by the computing device, an indication of user input detected at an area of a presence-sensitive input device, wherein the area of the presence-sensitive input device corresponds to a location of the display device at which the interface element in the graphical user interface is displayed;
determining, by the computing device, a characteristic of the user input;
determining, by the computing device, whether the characteristic of the user input is a first characteristic or a second characteristic different than the first characteristic;
responsive to determining that the characteristic of the user input is the first characteristic, outputting, by the computing device, for display at the display device, a first set of sub-elements; and
responsive to determining that the characteristic of the user input is the second characteristic, outputting, by the computing device, for display at the display device, a second set of sub-elements different from the first set of sub-elements, wherein each sub-element in the first set of sub-elements and each sub-element in the second set of sub-elements is associated with unique actions associated with the application.

2. The method of claim 1, wherein each sub-element in the first set of sub-elements comprises a respective graphical indication of a respective predicted action associated with the application.

3. The method of claim 2, wherein outputting the first set of sub-elements comprises:
determining, by the computing device, a context associated with the application;
determining, by the computing device, based at least in part on the context, one or more predicted actions associated with the application; and
for each predicted action of the one or more predicted actions, outputting, by the computing device, for display at the display device, a graphical indication of the respective predicted action as a sub-element in the first set of sub-elements.

4. The method of claim 1, wherein each sub-element in the second set of sub-elements comprises a respective graphical indication of a respective notification action associated with the application, wherein outputting the second set of sub-elements comprises:
determining, by an operating system executing on the computing device, one or more notification actions associated with the application; and
for each notification action of the one or more notification actions, outputting, by the computing device, for display at the display device, a graphical indication of the respective notification action as a sub-element in the second set of sub-elements.

5. The method of claim 1, wherein the user input comprises a user interaction representative of an instruction to display on the display device a limited representation of functionality of the application relative to an opened state of the application.

6. The method of claim 1, wherein determining whether the characteristic of the user input is the first characteristic or the second characteristic comprises determining, by the computing device, whether the characteristic of the user input is the first characteristic, the second characteristic, or a third characteristic different from the first characteristic and the second characteristic,
and wherein the method further comprises, responsive to determining that the characteristic of the user input is the third characteristic, outputting, by the computing device, for display at the display device, the first set of sub-elements and the second set of sub-elements.

7. The method of claim 6, wherein the first characteristic comprises a first pressure threshold, wherein the second characteristic comprises a second pressure threshold greater than the first pressure threshold, and wherein the third characteristic comprises a third pressure threshold greater than the second pressure threshold.

8. The method of claim 6, wherein the first characteristic comprises a horizontal gesture, wherein the second characteristic comprises a vertical gesture, and wherein the third characteristic comprises a diagonal gesture.

9. The method of claim 8, wherein outputting a respective set of sub-elements comprises:
determining, by the computing device, based on the indication of user input, a termination point on the presence-sensitive input device for the indication of user input;
outputting, by the computing device, for display at the display device, an expanded interface element extending from the interface element to an area in the graphical user interface corresponding to the termination point, wherein the expanded interface element includes the interface element and the respective set of sub-elements.

10. The method of claim 1, further comprising:
responsive to outputting the first set of sub-elements, receiving, by the computing device, an indication of second user input detected at a second area of the presence-sensitive input device, wherein the second area of the presence-sensitive input device corresponds to a location of the display device at which a first sub-element of the first set of sub-elements in the graphical user interface is displayed; and
outputting, by the computing device, for display at the display device, a second interface element in the graphical user interface, wherein the second interface element is associated with the first sub-element.

11. The method of claim 10, further comprising:
receiving, by the computing device, an indication of third user input detected at a third area of the presence-sensitive input device, wherein the third area of the presence-sensitive input device corresponds to a location of the display device at which the second interface element in the graphical user interface is displayed;
determining, by the computing device, a characteristic of the third user input;
determining, by the computing device, whether the characteristic of the third user input is the first characteristic or the second characteristic;
responsive to determining that the characteristic of the third user input is the first characteristic, outputting, by the computing device, for display at the display device, a third set of sub-elements; and
responsive to determining that the characteristic of the third user input is the second characteristic, outputting, by the computing device, for display at the display device, a fourth set of sub-elements different from the third set of sub-elements, wherein each sub-element in the third set of sub-elements and each sub-element in the fourth set of sub-elements is associated with unique actions associated with the application.

12. The method of claim 1, wherein the first set of sub-elements comprises one or more sub-elements associated with a first account for the application, and wherein the second set of sub-elements comprises one or more sub-elements associated with a second account for the application different than the first account.

13. The method of claim 1, wherein the user input comprises a subsequent user input, and wherein a state of the interface element comprises a static state, the method further comprising:
prior to receiving the indication of the subsequent user input:
receiving, by the computing device, an indication of an initial user input detected at the area of the presence-sensitive input device;
determining, by the computing device, that the initial user input satisfies an input requirement;
responsive to determining that the initial user input satisfies the input requirement, switching, by the computing device, the state of the interface element from the static state to a dynamic state.

14. A computing device comprising:
a display device;
a presence-sensitive input device;
at least one processor; and
a memory that stores instructions that, when executed, cause the at least one processor to:
display, at the display device, a graphical user interface including an interface element associated with an application on the computing device;
receive an indication of user input detected at an area of the presence-sensitive input device, wherein the area of the presence-sensitive input device corresponds to a location of the display device at which the interface element in the graphical user interface is displayed;
determine a characteristic of the user input;
determine whether the characteristic of the user input is a first characteristic or a second characteristic different than the first characteristic;
responsive to determining that the characteristic of the user input is the first characteristic, output, for display at the display device, a first set of sub-elements; and
responsive to determining that the characteristic of the user input is the second characteristic, output, for display at the display device, a second set of sub-elements different from the first set of sub-elements, wherein each sub-element in the first set of sub-elements and each sub-element in the second set of sub-elements is associated with unique actions associated with the application.

15. The computing device of claim 14, wherein each sub-element in the first set of sub-elements comprises a respective graphical indication of a respective predicted action associated with the application, and wherein the instructions that cause the at least one processor to output the first set of sub-elements comprise instructions that, when executed, cause the at least one processor to:
determine a context associated with the application;
determine based at least in part on the context, one or more predicted actions associated with the application; and
for each predicted action of the one or more predicted actions, output, for display at the display device, a graphical indication of the respective predicted action as a sub-element in the first set of sub-elements.

16. The computing device of claim 15, wherein the context comprises contextual information based on one or more of an application usage history associated with the application, a set of one or more shortcuts defined within the application, a predetermined list of actions, a current background task being performed by the application, an action associated with the interface element, a current time, a current location, calendar data, and message data.

17. The computing device of claim 14, wherein each sub-element in the second set of sub-elements comprises a respective graphical indication of a respective notification action associated with the application, and wherein the instructions that cause the at least one processor to output the second set of sub-elements comprise instructions that, when executed, cause the at least one processor to:
determine, using an operating system executing on the computing device, one or more notification actions associated with the application; and
for each notification action of the one or more notification actions, output, for display at the display device, a graphical indication of the respective notification action as an sub-element in the second set of sub-elements;
after outputting the second set of sub-elements, receive additional notification data associated with the application;
determine, using the operating system and based at least in part on the additional notification data, one or more additional notification actions associated with the application; and
for each additional notification action of the one or more additional notification actions, output, for display at the display device, a graphical indication of the respective additional notification action as a sub-element in a third set of sub-elements, wherein each sub-element in the third set of sub-elements is associated with unique actions associated with the application.

18. A method comprising:
performing, by one or more processors of a computing device, a first call of an application programming interface (API) to generate, based on a data set, an interface element conforming to a first graphical interface modality of a plurality of graphical interface modalities for an application;
outputting, by the one or more processors and for display, the first interface element;
performing, by the one or more processors, a second call of the API to generate, based on the data set, a second interface element conforming to a second graphical interface modality of the plurality of graphical interface modalities for the application, the second graphical interface modality being different than the first graphical interface modality; and
outputting, by the one or more processors and for display, the second interface element.

19. The method of claim 18, wherein the plurality of graphical interface modalities include two or more of: 1) an icon; 2) a long-press menu; 3) a widget; 4) a bubble; 5) a graphical card; 6) an automotive modality; and 7) a wearable modality.

20. The method of claim 18, wherein performing the second call of the API comprises performing, responsive to receiving data indicative of a user input, the second call of the API to generate, based on the data set, the second interface element conforming to the second graphical interface modality, and wherein the API comprises an API provided by an operating system supporting execution of the application.
